(19) United States
(12) Patent Application Publication
(10) Pub. No.: US 2026/0351505 A1
(43) Pub. Date: Nov. 5, 2026

(54) ELECTRONIC COMPONENT UNIT AND METHOD FOR MANUFACTURING ELECTRONIC COMPONENT UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kuniaki HAYASHI, Mie (JP); Hideo TAKAHASHI, Mie (JP); Osamu NAKAYAMA, Mie (JP); Teruo HARA, Mie (JP); Akihiro NISHITANI, Mie (JP); Yuhei YAMADA, Mie (JP)

(21) Appl. No.: 19/488,072

(22) PCT Filed: Jun. 3, 2024
(86) PCT No.: PCT/JP2024/020162

§ 371 Date: Nov. 26, 2025

(30) Foreign Application Priority Data
Jun. 1, 2023 (JP) 2023-090832
Jan. 11, 2024 (WO) PCT/JP2024/000420

(51) Int. Cl. H01H 85/20; H01H 69/02

(52) U.S. Cl. CPC H01H 85/20; H01H 69/02

(57) ABSTRACT

An electronic component unit includes: a first terminal configured to be electrically connected to a counterpart member; a second terminal configured to be electrically connected directly or indirectly to a wiring member; a resin part configured to cover a part of the first terminal and a part of the second terminal; and an electronic component, wherein the resin part maintains a distance between the first terminal and the second terminal, the first terminal includes a first connection portion exposed from the resin part, the second terminal includes a second connection portion exposed from the resin part, and the electronic component includes a first electrode mounted on the first connection portion, and a second electrode mounted on the second connection portion.

### TECHNICAL FIELD

The present disclosure relates to an electronic component unit and a method for manufacturing an electronic component unit.

### BACKGROUND

High-voltage battery packs used in electric automobiles, hybrid automobiles, and the like are typically composed of multiple battery cells stacked together and electrically connected in series or parallel by wiring modules. As such a wiring module, the conductor module described in JP 2019-032928 A (Patent Document 1 below) is conventionally known. The conductor module described in Patent Document 1 includes a routing material and a plurality of busbars. The routing material includes a plurality of wirings that electrically connect the busbars and a battery module monitoring unit, and electronic components provided at intermediate positions on the wirings. In Patent Document 1, a flexible printed circuit board (FPC) is given as an example of the routing material, and fuses are given as examples of the electronic components. By using an FPC as the routing material, it is easy to install fuses in the routing material through mounting.

### PRIOR ART DOCUMENT

### Patent Document

Patent Document 1: JP 2019-032928 A

### SUMMARY OF THE INVENTION

### Problems to be Solved

In the above-described conductor module, if the battery cells, busbars, or the like are changed, it is necessary to separately design and prepare routing materials. Therefore, it is difficult to reduce the manufacturing cost of wiring materials.

### Means to Solve the Problem

An electronic component unit according to the present disclosure is directed to an electronic component unit including: a first terminal configured to be electrically connected to a counterpart member; a second terminal configured to be electrically connected directly or indirectly to a wiring member; a resin part configured to cover a part of the first terminal and a part of the second terminal; and an electronic component, wherein the resin part maintains a distance between the first terminal and the second terminal, the first terminal includes a first connection portion exposed from the resin part, the second terminal includes a second connection portion exposed from the resin part, and the electronic component includes a first electrode mounted on the first connection portion, and a second electrode mounted on the second connection portion.

A method for manufacturing an electronic component unit according to the present disclosure is directed to a method including: a terminal forming step of forming a first terminal and a second terminal; a resin part forming step of forming, through insert molding, a resin part that covers a part of the first terminal and a part of the second terminal, the resin part exposing an outer surface of the first terminal so that the exposed portion serves as a first connection portion and exposing an outer surface of the second terminal so that the exposed portion serves as a second connection portion; and a mounting step of mounting, among a first electrode and a second electrode of an electronic component, the first electrode on the first connection portion and the second electrode on the second connection portion.

### Effect of the Invention

According to the present disclosure, it is possible to provide an electronic component unit that can reduce the manufacturing cost.

### BRIEF DESCRIPTION OF THE DRAWINGS

FIG. 1 is a perspective view of an electronic component unit according to Embodiment 1, showing a state where the electronic component unit is connected to an electric wire.

FIG. 2 is a plan view of the electronic component unit connected to the wire, according to Embodiment 1.

FIG. 3 is a cross-sectional view taken along a line A-A in FIG. 2.

FIG. 4 is a plan view of a first terminal and a second terminal according to Embodiment 1.

FIG. 5 is a plan view of an intermediate molded body according to Embodiment 1.

FIG. 6 is a plan view of the electronic component unit according to Embodiment 1.

FIG. 7 is a perspective view of a wiring module including the electronic component unit according to Embodiment 1.

FIG. 8 is a perspective view of an electronic component unit according to Embodiment 2, showing a state where the electronic component unit is connected to a wire.

FIG. 9 is a cross-sectional view of the electronic component unit according to Embodiment 2, corresponding to FIG. 3 of Embodiment 1.

FIG. 10 is a perspective view of an electronic component unit according to Embodiment 3, showing a state where the electronic component unit is connected to a wire.

FIG. 11 is a cross-sectional view of the electronic component unit according to Embodiment 3, corresponding to FIG. 3 of Embodiment 1.

FIG. 12 is a cross-sectional view of an electronic component unit according to Embodiment 4, corresponding to FIG. 3 of Embodiment 1.

FIG. 13 is a perspective view of an electronic component unit according to Embodiment 5, showing a state where the electronic component unit is connected to a wire.

FIG. 14 is a plan view of an electronic component unit according to Embodiment 6, showing a state where the electronic component unit is connected to a wire.

FIG. 15 is a cross-sectional view taken along a line B-B in FIG. 14.

FIG. 16 is a perspective view of an electronic component unit according to Embodiment 7, showing a state where the electronic component unit is connected to a wire.

FIG. 17 is a plan view of the electronic component unit connected to the wire, according to Embodiment 7.

FIG. 18 is a cross-sectional view taken along a line C-C in FIG. 17.

FIG. 19 shows how a third terminal is inserted into a cavity, in the cross-sectional view taken along the line C-C in FIG. 17.

FIG. 20 shows the state where the third terminal is inserted into the cavity and a retainer is in a temporary engagement position, in the cross-sectional view taken along the line C-C in FIG. 17.

FIG. 21 is a side view of the electronic component unit connected to the wire, according to Embodiment 7.

FIG. 22 is a cross-sectional view taken along a line D-D in FIG. 21, with a second terminal, the third terminal and the wires omitted.

FIG. 23 is a side view of the electronic component unit according to Embodiment 7, except for the third terminal, showing the state where the retainer is in the temporary engagement position.

FIG. 24 is a cross-sectional view taken along a line E-E in FIG. 23.

FIG. 25 is a plan view showing a first terminal, the second terminal, and a resin part according to Embodiment 7.

FIG. 26 is a perspective view of a cross section taken along a line F-F in FIG. 25.

FIG. 27 is a cross-sectional view taken along a line G-G in FIG. 25.

FIG. 28 is a plan view of the first terminal and the second terminal according to Embodiment 7.

FIG. 29 is a perspective view of an electronic component unit according to a modification of Embodiment 1, showing a state where the electronic component unit is connected to a wire.

FIG. 30 is a perspective view of an electronic component unit according to another embodiment, showing a state where the electronic component unit is connected to a flexible substrate.

### DETAILED DESCRIPTION TO EXECUTE THE INVENTION

### Description of Embodiments of Present Disclosure

First, embodiments of the present disclosure will be listed and described.

[1] An electronic component unit according to the present disclosure includes: a first terminal configured to be electrically connected to a counterpart member; a second terminal configured to be electrically connected directly or indirectly to a wiring member; a resin part configured to cover a part of the first terminal and a part of the second terminal; and an electronic component, wherein the resin part maintains a distance between the first terminal and the second terminal, the first terminal includes a first connection portion exposed from the resin part, the second terminal includes a second connection portion exposed from the resin part, and the electronic component includes a first electrode mounted on the first connection portion, and a second electrode mounted on the second connection portion.

According to this configuration, the electronic component can be easily incorporated into the electronic component unit by mounting. Also, even if the counterpart member or the wiring member is changed, there may be cases where it is not necessary to redesign the electronic component unit, resulting in a reduction in manufacturing cost of the electronic component unit. Also, it is conceivable that the material of the first terminal will need to be changed to copper, aluminum, or the like, due to a change in the material of the counterpart member. However, using the above-described electronic component unit enables to perform changing to dissimilar metals.

[2] In the above-described configuration [1], preferably, the resin part includes a peripheral wall portion that has a portion protruding from the first connection portion and the second connection portion and is arranged in the periphery of the electronic component.

According to this configuration, the electronic component can be protected by the peripheral wall portion.

[3] In the above-described configuration [2], preferably, the peripheral wall portion surrounds the first connection portion and the second connection portion.

According to this configuration, the peripheral wall portion can prevent foreign objects and the like from coming into contact with the electronic component, thereby making it possible to prevent stress from occurring at the connection portion between the first connection portion and the first electrode, and at the connection portion between the second connection portion and the second electrode.

[4] The electronic component unit according to any one of the above-described configurations [1] to [3] preferably further includes: a cover member configured to cover the electronic component.

According to this configuration, by providing the cover member, it is possible to prevent dew condensation water and the like from attaching to the electronic component. Accordingly, the first electrode and the second electrode can be prevented from shorting via dew condensation water and the like.

[5] The electronic component unit according to any one of the above-described configurations [1] to [4] preferably further includes: a third terminal to which the wiring member is connected, wherein the second terminal includes a first terminal connection portion connected to the third terminal, and the third terminal includes a second terminal connection portion connected to the first terminal connection portion by mating.

According to this configuration, connection between the wiring member and the second terminal is facilitated.

[6] The electronic component unit according to the above-described configuration [5] preferably further includes: a retainer attached to the resin part and configured to retain the third terminal.

According to this configuration, the third terminal can be held with respect to the resin part, so the third terminal is likely to be positioned with respect to the resin part.

[7] In any one of the above-described configurations [1] to [6], preferably, the first terminal or the second terminal has cutouts that are recessed from an outer edge thereof, and the cutouts define the first connection portion or the second connection portion.

According to this configuration, by defining the first connection portion or the second connection portion using the cutouts, the size of the first connection portion or the second connection portion is appropriately adjusted, and it is thus possible to control heat transfer from the first connection portion or the second connection portion when mounting the electronic component.

[8] In the above-described configuration [7], preferably, the resin part has a groove that is recessed with respect to the first connection portion and the second connection portion, inner surfaces of the groove are respectively continuous with the first connection portion and the second connection portion, and the groove is partially located inside the cutouts.

According to this configuration, when forming the resin part, it is possible to prevent molten resin from moving to the outer surfaces of the first connection portion and the second connection portion via the cutouts. This can prevent burrs from occurring on the first connection portion and the second connection portion.

[9] In any one of the above-described configurations [1] to [8], preferably, a thickness of the first terminal in the first connection portion is different from a thickness of the second terminal in the second connection portion, and the first connection portion and the second connection portion are arranged at the same height.

Even if the thicknesses of the first terminal and the thicknesses of the second terminal differ from each other, the electronic component can be easily mounted because the first connection portion and the second connection portion are positioned at the same height.

[10] A method for manufacturing an electronic component unit according to the present disclosure includes: a terminal forming step of forming a first terminal and a second terminal; a resin part forming step of forming, through insert molding, a resin part that covers a part of the first terminal and a part of the second terminal, the resin part exposing an outer surface of the first terminal so that the exposed portion serves as a first connection portion and exposing an outer surface of the second terminal so that the exposed portion serves as a second connection portion; and a mounting step of mounting, among a first electrode and a second electrode of an electronic component, the first electrode on the first connection portion and the second electrode on the second connection portion.

According to the method for manufacturing electronic component unit, by forming the resin part in which the first connection portion and the second connection portion are exposed in the resin part forming step, the electronic component can be easily incorporated into the electronic component unit in the mounting step. Also, even if the counterpart members to which the first terminal and the second terminal are respectively connected are changed, there may be cases where it is not necessary to redesign the electronic component unit, resulting in a reduction in manufacturing cost of the electronic component unit.

### Detail of Embodiments of Present Disclosure

The following will describe embodiments of the present disclosure. The present disclosure is not limited to these examples, but is intended to include all changes within the meaning and scope equivalent to the claims. For convenience of description, some features may be exaggerated or simplified in the drawings. In addition, the dimensional ratios of each part may differ depending on the drawing. In the context of the present specification, the terms “orthogonal” and “parallel” include not only exactly orthogonal and parallel, but also substantially orthogonal and parallel to the extent that the functions and effects of the embodiments are achieved.

The drawings show three mutually perpendicular directions, which are indicated as a first direction D1, a second direction D2, and a third direction D3, respectively. That is, the first direction D1 and the second direction D2 are mutually perpendicular, the first direction D1 and the third direction D3 are mutually perpendicular, and the second direction D2 and the third direction D3 are mutually perpendicular. By indicating arrows on both sides of the solid lines indicating each direction, not only the direction of the arrow on the side with the reference sign, but also the direction of the arrow on the side without the reference sign is regarded as indicating the direction.

### Embodiment 1

### Electronic Component Unit 10

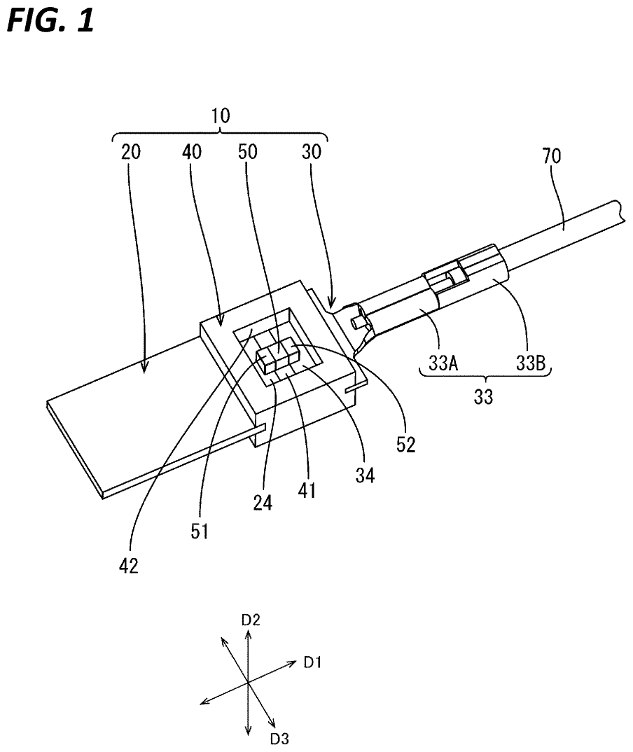

The following will describe Embodiment 1 of the present disclosure with reference to FIGS. 1 to 7. As shown in FIGS. 1 to 3, an electronic component unit 10 of the present embodiment includes a first terminal 20, a second terminal 30, a resin part 40, and an electronic component 50. Note that when there are multiple identical members, reference signs may be added to only some of the members, and reference signs for other members may be omitted.

### First Terminal 20

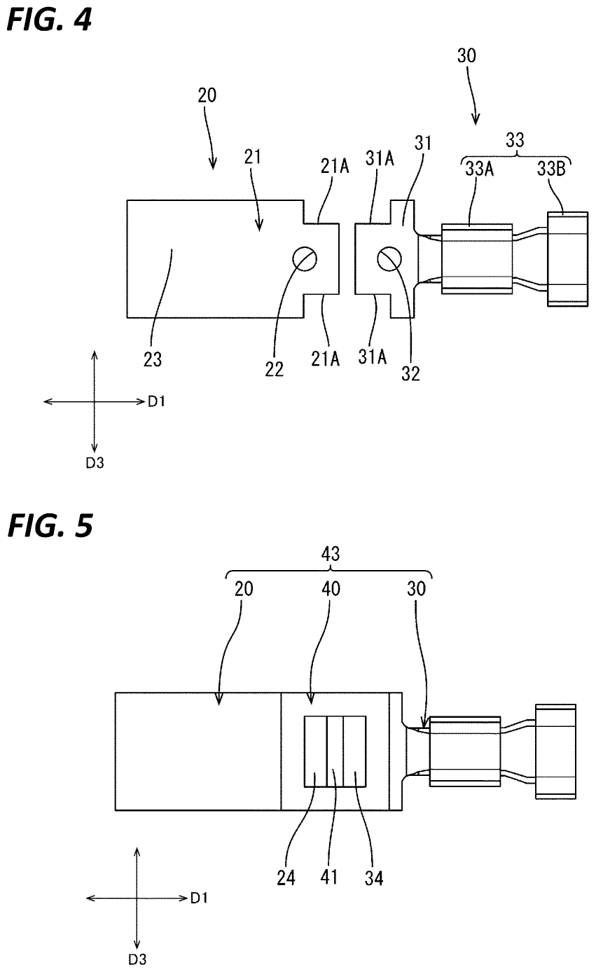

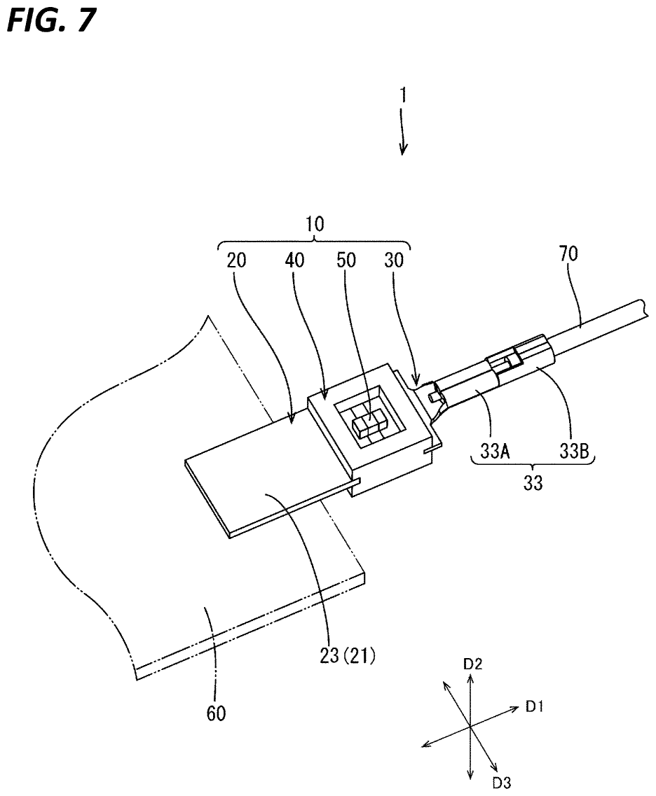

The first terminal 20 is made of conductive metal. Examples of conductive metal include aluminum and a copper alloy. Also, examples of surface treatments for conductive metal include nickel plating and tin plating. Specifically, there may be a first terminal in which nickel plating is formed on the surface of aluminum, a first terminal in which tin plating is formed on the surface of aluminum, or a first terminal in which tin plating is formed on the surface of a copper alloy. As shown in FIG. 4, the first terminal 20 has a plate-shaped portion 21 in a rectangular plate shape and a through hole 22 that passes through the plate-shaped portion 21. The through hole 22 is located at a position close to an end of the plate-shaped portion 21 in the extending direction of the plate-shaped portion 21. The plate-shaped portion 21 has two recesses 21A at both ends in the width direction of the plate-shaped portion 21 (a direction orthogonal to both the extending direction and the thickness direction of the plate-shaped portion 21). The recesses 21A are respectively formed by being recessed from the end edges of the plate-shaped portion 21 in the width direction. The plate-shaped portion 21 has a counterpart member connection portion 23 that is electrically connected to a counterpart member. The counterpart member is, for example, a busbar 60 (see FIG. 7). The connection between the counterpart member connection portion 23 and the counterpart member is made by, for example, welding, soldering, and the like.

### Second Terminal 30

The second terminal 30 is made of a conductive metal. The metal constituting the second terminal 30 may be different from the metal constituting the first terminal 20. Examples of conductive metal include a copper alloy. Also, examples of surface treatments for conductive metal include tin plating. Specifically, there may be a second terminal in which tin plating is formed on the surface of a copper alloy. As shown in FIG. 4, the second terminal 30 has a plate-shaped portion 31 in a rectangular plate shape, a through hole 32 that passes through the plate-shaped portion 31, and a barrel portion 33. The barrel portion 33 is formed continuously from the plate-shaped portion 31 in the extending direction of the second terminal 30. The plate-shaped portion 31 has two recesses 31A at both ends of the second terminal 30 in the width direction (direction orthogonal to both the extending direction of the second terminal 30 and the thickness direction of the plate-shaped portion 31). The recesses 31A are formed by being recessed from the respective end edges of the second terminal 30 in the width direction.

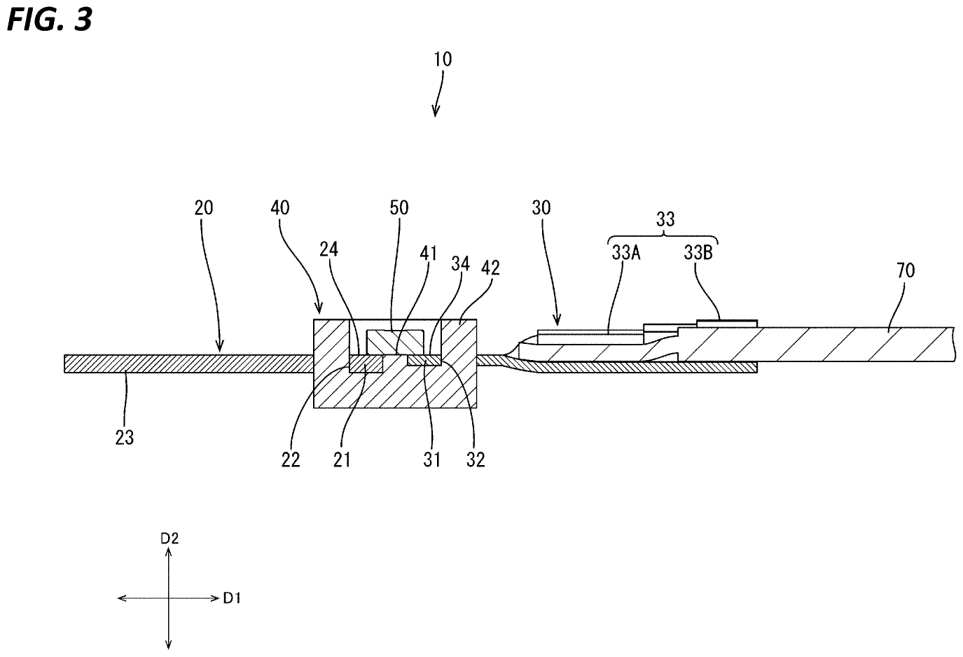

The barrel portion 33 includes a core wire crimping section 33A and an insulated coating crimping section 33B (an example of a fixing portion). The core wire crimping section 33A is located between the plate-shaped portion 31 and the insulated coating crimping section 33B in the extending direction of the second terminal 30. As shown in FIG. 3, the core wire crimping section 33A is crimped to the core wire of a wire 70 (an example of a wiring member). The core wire crimping section 33 A electrically connects the second terminal 30 to the wire 70. The insulated coating crimping section 33B is crimped to an insulation coating of the wire 70. The insulated coating crimping section 33B can be used to fix the wire 70 to the second terminal 30. When tensile stress is applied, for example, to the wire 70, the insulated coating crimping section 33B suppresses transmission of the tensile stress to the core wire crimping section 33A. This makes it easier to maintain the electrical connection between the wire 70 and the second terminal 30.

### Resin Part 40

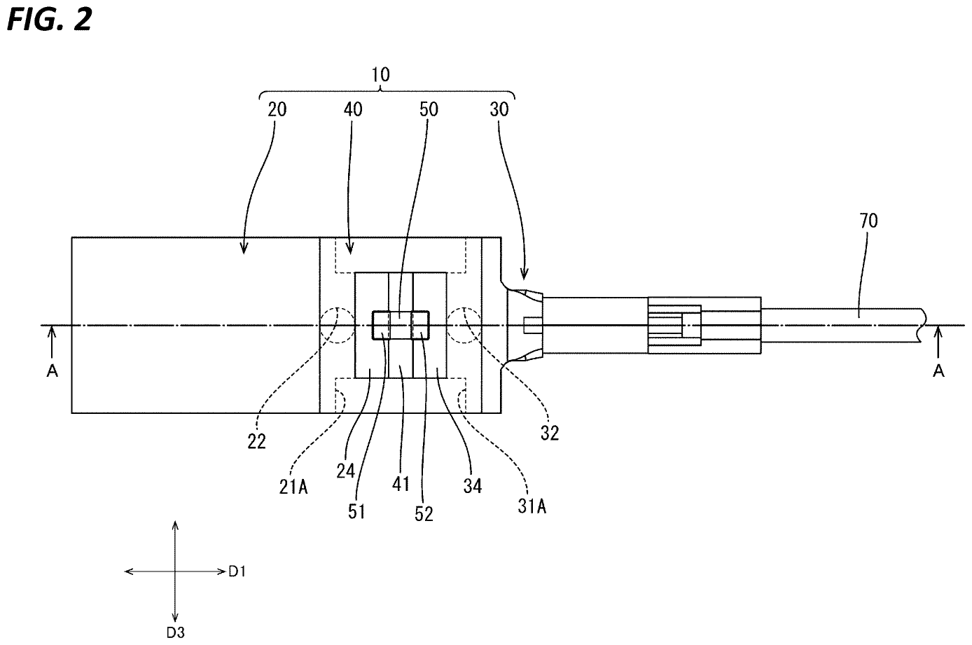

The resin part 40 is made of an insulating synthetic resin. As shown in FIGS. 1 to 3, the resin part 40 is located between the first terminal 20 and the second terminal 30, and covers a part of the first terminal 20 and a part of the second terminal 30. The resin part 40 is formed in one piece with the first terminal 20 and the second terminal 30 by insert molding, as will be described later. As shown in FIGS. 2 and 3, during insert molding, the through holes 22 and 32 and the recesses 21A and 31A are filled with molten resin, which is the raw material of the resin part 40, so that the first terminal 20 and the second terminal 30 are held on the resin part 40. The resin part 40 positions the first terminal 20 and the second terminal 30 so that they do not come into direct contact with each other. The first terminal 20 and the second terminal 30 are spaced apart from each other in the first direction D1. The first terminal 20 is arranged so that the extending direction of the plate-shaped portion 21 of the first terminal 20 matches the first direction D1. The second terminal 30 is arranged so that the extending direction of the second terminal 30 matches the first direction D1.

### Placement Surface 41

As shown in FIG. 3, the resin part 40 has a placement surface 41. The placement surface 41 is located between the first terminal 20 and the second terminal 30. The placement surface 41 is a surface on which an electronic component 50 is placed. The placement surface 41 is orthogonal to the second direction D2 (referred to hereinafter as a vertical direction). The second direction D2 matches the thickness direction of the plate-shaped portions 21 and 31.

### First Connection Portion 24

A first connection portion 24, which is a part of the outer surface of the plate-shaped portion 21, is exposed from the placement surface 41. The first connection portion 24 is located adjacent to the placement surface 41 and exposed from the resin part 40. The first connection portion 24 is arranged at the end of the first terminal 20 that is close to the second terminal 30 in the first direction D1. The first connection portion 24 is flush with the placement surface 41. In other words, the first connection portion 24 is parallel to the placement surface 41 and is disposed at the same position as the placement surface 41 in the second direction D2. The first connection portion 24 is continuous with the placement surface 41 in the first direction D1. Here, “flush” refers to a state where two parallel surfaces are smoothly connected to each other without any step, but in this specification, in addition to a flush state, a state that is recognized as substantially flush is also included. The state that is recognized as substantially flush refers to, for example, a state where a minute step appears between the placement surface 41 and the first connection portion 24 due to manufacturing tolerances, thermal expansion, or the like, or a state where the placement surface 41 and the first connection portion 24 slightly intersect with each other and are not strictly parallel.

### Second Connection Portion 34

A second connection portion 34, which is a part of the outer surface of the plate-shaped portion 31, is exposed from the placement surface 41. The second connection portion 34 is located adjacent to the placement surface 41 and exposed from the resin part 40. The second connection portion 34 is arranged at the end of the second terminal 30 that is close to the first terminal 20 in the first direction D1. The second connection portion 34 is flush with the placement surface 41. The thickness of the plate-shaped portion 31 at the second connection portion 34 differs from the thickness of the plate-shaped portion 21 at the first connection portion 24, but the thickness of the plate-shaped portion 31 at the second connection portion 34 may be the same as the thickness of the plate-shaped portion 21 at the first connection portion 24. The thickness of the plate-shaped portion 31 at the second connection portion 34 of the present disclosure is smaller than the thickness of the plate-shaped portion 21 at the first connection portion 24. Therefore, even if the plate-shaped portions 21 and 31 have different thicknesses, the first connection portion 24 and the second connection portion 34 are positioned at the same height, and thus the electronic component 50 can be easily mounted.

### Peripheral Wall Portion 42

As shown in FIG. 1, the resin part 40 includes a peripheral wall portion 42 that protrudes from the first connection portion 24 and the second connection portion 34. The peripheral wall portion 42 protrudes, for example, in a direction orthogonal to the first connection portion 24 and the second connection portion 34. Also, the peripheral wall portion 42 extends, for example, from the placement surface 41 toward one side (the upper side) in the second direction D2. The peripheral wall portion 42 is arranged so as to surround the electronic component 50 in a direction orthogonal to the second direction D2. Note that the peripheral wall portion 42 is disposed so as not to come into contact with the electronic component 50. As shown in FIG. 3, the height (dimension in the second direction D2) of the peripheral wall portion 42 from the placement surface 41 is greater than the height of the electronic component 50. The peripheral wall portion 42 has four inner walls that form a square shape when viewed in the second direction D2. The length of the inner walls extending in the first direction D1 is approximately the same as the length of the inner walls extending in the third direction D3.

### Electronic Component 50

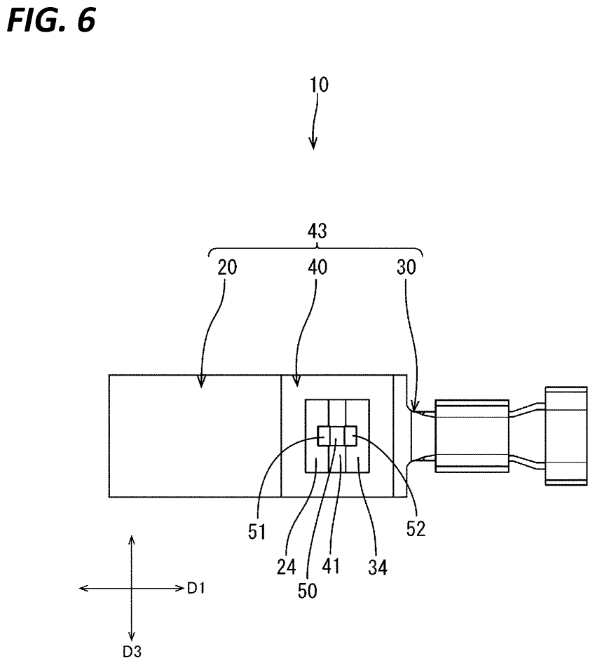

Examples of electronic components include fuses (such as chip fuses and fuses with lead wires), resistors (such as chip resistors and resistors with lead wires), and metal pieces. In the present disclosure, a chip fuse is taken as an example. As shown in FIG. 1, the electronic component 50 has a first electrode 51 and a second electrode 52. If a large current flows and the electronic component 50 melts, the first electrode 51 and the second electrode 52 will be electrically insulated. The electronic component 50 is placed on the placement surface 41. The first electrode 51 is placed on the first connection portion 24, and the second electrode 52 is placed on the second connection portion 34. The first electrode 51 and the first connection portion 24 are connected to each other by soldering. The second electrode 52 and the second connection portion 34 are connected to each other by soldering. That is, the electronic component 50 is mounted on an intermediate molded body 43 (see FIG. 5) consisting of the first terminal 20, the second terminal 30, and the resin part 40. Therefore, the electronic component 50 can be easily incorporated into the electronic component unit 10 by the mounting step (see FIG. 6).

The electronic component unit 10 is a member in which the electronic component 50 is mounted without using a flexible printed circuit (FPC). In other words, the first terminal 20, the second terminal 30, and the resin part 40 form the first connection portion 24 and the second connection portion 34 on which the electronic component 50 can be mounted. Therefore, it is easy to reduce the manufacturing cost of the electronic component unit 10. Note that when a chip-type electronic component is used as the electronic component, space can be saved by the length of the lead wire compared to a case where an electronic component with lead wires is crimped. Also, when a metal piece is used as the electronic component, it is possible to join dissimilar metals, such as copper on one side and aluminum on the other side.

### Wiring Module 1

The electronic component unit 10 of the present embodiment can be used, for example, in a power storage module installed in vehicles such as electric automobiles or hybrid automobiles. The power storage module includes a plurality of power storage elements (not shown) and a wiring module 1 attached to the plurality of power storage elements. As shown in FIG. 7, the wiring module 1 includes the electronic component unit 10, the busbar 60 connected to the counterpart member connection portion 23 of the first terminal 20, and the wire 70 connected to the barrel portion 33 of the second terminal 30. The busbar 60 is connected to electrode terminals of the plurality of power storage elements. The wire 70 is configured to be connected to an ECU (Electronic Control Unit) or the like via a connector (not shown). The wires 70 function as voltage detection wires.

The wiring module 1, which includes the electronic component unit 10, has the wires 70 as voltage detection wires, instead of an FPC. Therefore, the wiring module 1 can be manufactured at a lower cost compared to a wiring module in which an FPC is used as voltage detection wires.

### Method for Manufacturing Electronic Component Unit 10

The configuration of the electronic component unit 10 has been described above, and the following describes an example of a method for manufacturing the electronic component unit 10. First, a metal sheet material is pressed to form the first terminal 20 and the second terminal 30 (terminal forming step, see FIG. 4).

Next, insert molding of the resin part 40 is performed, with a part of the first terminal 20 and a part of the second terminal 30 used as inserts (resin part forming step). The first terminal 20 and the second terminal 30 are placed in the mold, and the mold is filled with molten resin, which is the raw material of the resin part 40. At this time, the first terminal 20 and the second terminal 30 are arranged so that they do not come into direct contact with each other. In addition, the first terminal 20 and the second terminal 30 are appropriately positioned in the mold in a manner such that the first connection portion 24 and the second connection portion 34 adjacent to the placement surface 41 are exposed from the resin part 40 and the first connection portion 24 and the second connection portion 34 are flush with the placement surface 41. Once the resin has hardened, the mold is removed, and the intermediate molded body 43 is obtained (see FIG. 5).

The electronic component 50 is placed on the placement surface 41 of the intermediate molded body 43, the first electrode 51 is mounted on the first connection portion 24, and the second electrode 52 is mounted on the second connection portion 34 (mounting step, see FIG. 6). With this, the electronic component unit 10 is completely manufactured.

### Operations and Effects of Embodiment 1

(1-1) The electronic component unit 10 according to the present disclosure includes: a first terminal 20 configured to be electrically connected to a counterpart member (busbar 60); a second terminal 30 configured to be electrically connected directly or indirectly to a wiring member (wire 70); a resin part 40 configured to cover a part of the first terminal 20 and a part of the second terminal 30; and an electronic component 50, wherein the resin part 40 maintains a distance between the first terminal 20 and the second terminal 30, the first terminal 20 includes a first connection portion 24 exposed from the resin part 40, the second terminal 30 includes a second connection portion 34 exposed from the resin part 40, and the electronic component 50 includes a first electrode 51 mounted on the first connection portion 24, and a second electrode 52 mounted on the second connection portion 34.

According to this configuration, the electronic component 50 can be easily incorporated into the electronic component unit 10 by mounting. Also, even if the counterpart member or the wiring member is changed, there may be cases where it is not necessary to redesign the electronic component unit 10, resulting in a reduction in manufacturing cost of the electronic component unit 10. Also, it is conceivable that the material of the first terminal 20 will need to be changed to a dissimilar metal, such as copper or aluminum, due to a change in the material of the counterpart member (busbar 60). In that case, by using the above-described electronic component unit 10, it is possible to appropriately change the material of the first terminal 20 to a dissimilar metal, regardless of the material of the second terminal 30.

(1-2) In Embodiment 1, the resin part 40 includes the peripheral wall portion 42 that has a portion protruding from the first connection portion 24 and the second connection portion 34 and is located in the periphery of the electronic component 50.

According to this configuration, the electronic component 50 can be protected by the peripheral wall portion 42.

(1-3) In Embodiment 1, the peripheral wall portion 42 surrounds the first connection portion 24 and the second connection portion 34.

According to this configuration, the peripheral wall portion 42 can prevent foreign objects and the like from coming into contact with the electronic component 50, thereby making it possible to prevent stress from occurring at the connection portion between the first connection portion 24 and the first electrode 51, and at the connection portion between the second connection portion 34 and the second electrode 52.

(1-4) In Embodiment 1, a thickness of the plate-shaped portion 21 in the first connection portion 24 differs from a thickness of the plate-shaped portion 31 in the second connection portion 34, and the first connection portion 24 and the second connection portion 34 are positioned at the same height.

Even if the plate-shaped portions 21 and 31 have different thicknesses, the first connection portion 24 and the second connection portion 34 are positioned at the same height, and thus the electronic component 50 can be easily mounted.

(1-5) The method for manufacturing an electronic component unit 10 according to the present disclosure includes: a terminal forming step of forming a first terminal 20 and a second terminal 30; a resin part forming step of forming, through insert molding, a resin part 40 that covers a part of the first terminal 20 and a part of the second terminal 30, the resin part 40 exposing an outer surface of the first terminal 20 so that the exposed portion serves as a first connection portion 24 and exposing an outer surface of the second terminal 30 so that the exposed portion serves as a second connection portion 34; and a mounting step of mounting, among a first electrode 51 and a second electrode 52 of an electronic component 50, the first electrode 51 on the first connection portion 24 and the second electrode 52 on the second connection portion 34.

According to the method for manufacturing electronic component unit 10, by forming the resin part 40 in which the first connection portion 24 and the second connection portion 34 are exposed in the resin part forming step, the electronic component 50 can be easily incorporated into the electronic component unit 10 in the mounting step. Also, even if the counterpart members to which the first terminal 20 and the second terminal 30 are respectively connected are changed, there may be cases where it is not necessary to redesign the electronic component unit 10, resulting in a reduction in manufacturing cost of the electronic component unit 10.

### Embodiment 2

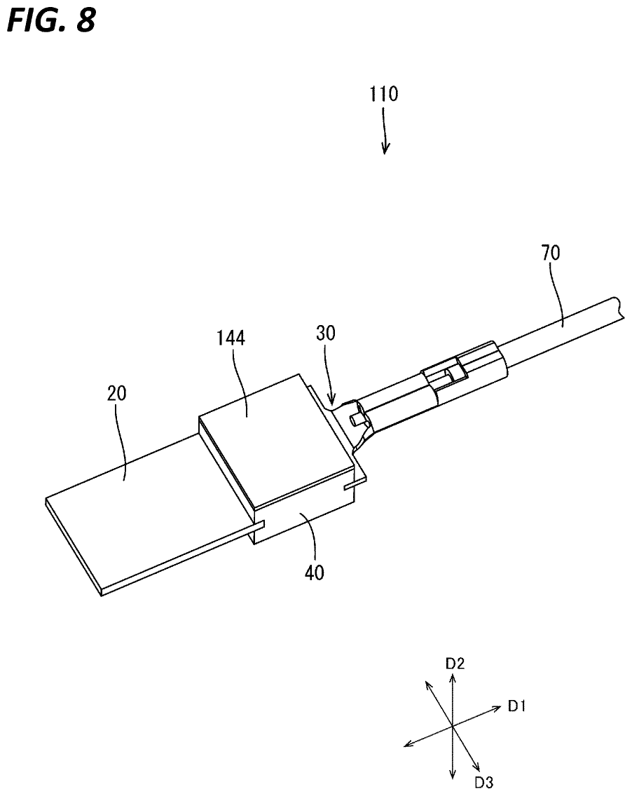

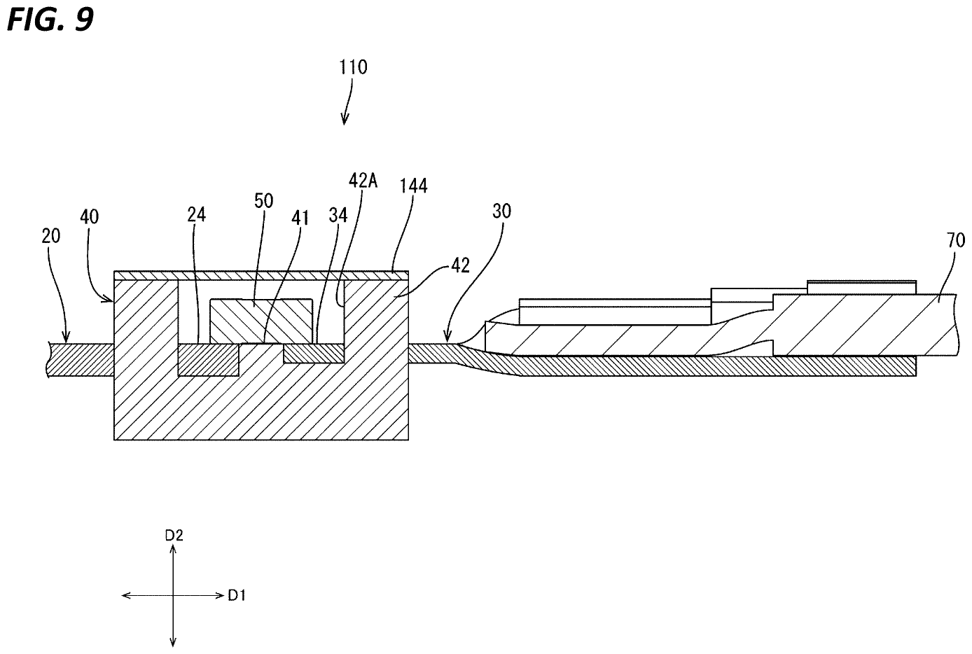

The following will describe Embodiment 2 of the present disclosure with reference to FIGS. 8 and 9. An electronic component unit 110 according to Embodiment 2 is configured in substantially the same manner as in Embodiment 1, except that it further includes a lid portion 144 (an example of a cover member), and thus, descriptions of the same components, operations, and effects as in Embodiment 1 are omitted.

### Lid Portion 144

The lid portion 144 is made of an insulating synthetic resin, an insulating tape, or the like. As shown in FIG. 9, the lid portion 144 is attached to the upper end face of the peripheral wall portion 42 and closes an opening 42A formed by the peripheral wall portion 42. The lid portion 144 and the electronic component 50 are spaced from each other. The electronic component unit 110 of Embodiment 2 can be manufactured by attaching the lid portion 144 to the electronic component unit 10 of Embodiment 1.

According to Embodiment 2, the lid portion 144 can prevent water droplets from entering the opening 42A of the peripheral wall portion 42. Therefore, it is possible to prevent the first connection portion 24 and the second connection portion 34 from becoming conductive via water droplets after the electronic component 50 is melted.

### Embodiment 3

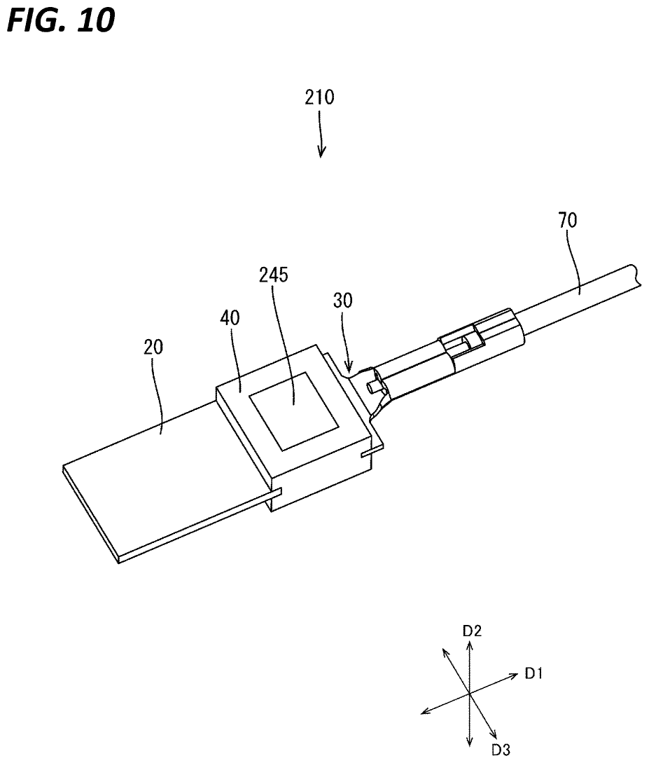

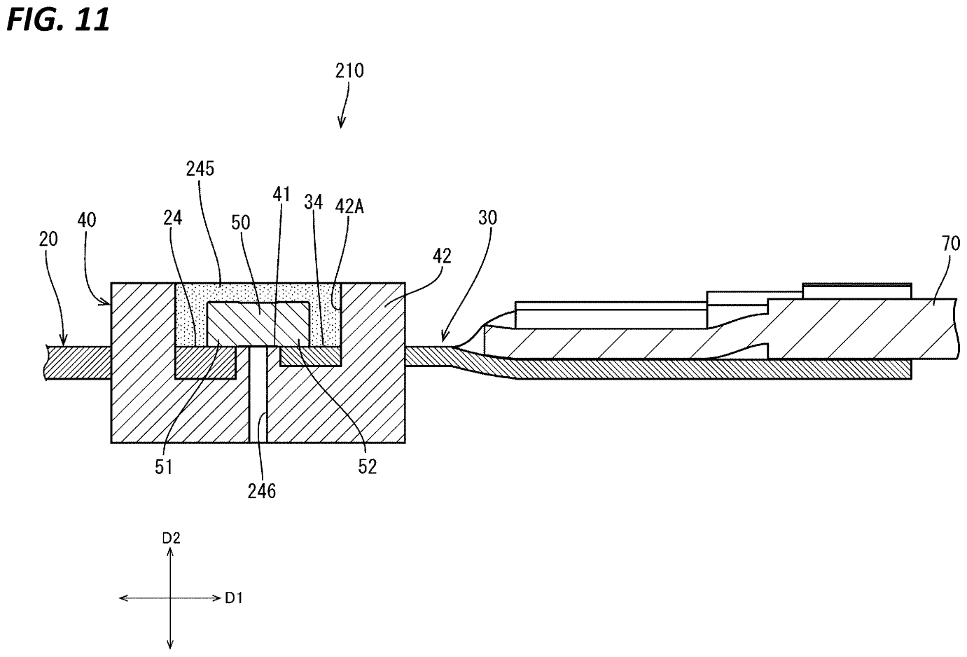

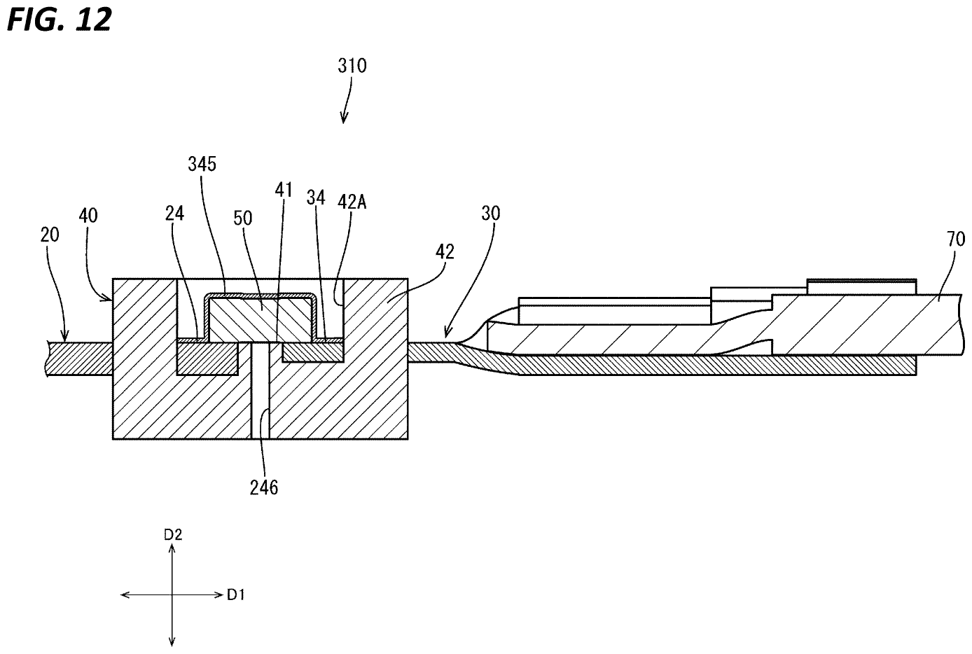

The following will describe Embodiment 3 of the present disclosure with reference to FIGS. 10 and 11. An electronic component unit 210 according to Embodiment 3 is configured in substantially the same manner as in Embodiment 1, except that it further includes a sealing portion 245 (an example of the cover member), and thus, descriptions of the same components, operations, and effects as in Embodiment 1 are omitted.

### Sealing Portion 245

The sealing portion 245 is made of a curable insulating resin. The sealing portion 245 may be made of a resin different from the synthetic resin constituting the resin part 40. The sealing portion 245 may be transparent. The sealing portion 245 in Embodiment 3 is, for example, a potting agent. As shown in FIG. 11, the sealing portion 245 is arranged to fill the space within the opening 42A of the peripheral wall portion 42. The sealing portion 245 adheres to the outer surface of the electronic component 50, the first connection portion 24, the second connection portion 34, and the placement surface 41. After the mounting step, the sealing portion 245 is formed by filling the opening 42A with liquid insulating resin, which is not yet hardened, and then hardening the insulating resin. Note that, on the inner side of the peripheral wall portion 42, a recess with a bottom is formed by the inner peripheral surface of the peripheral wall portion 42, the surface of the portion between the first terminal 20 and the second terminal 30 of the resin part 40 that is exposed to the inner side of the peripheral wall portion 42, the surface of the first terminal 20 that is exposed to the inner side of the peripheral wall portion 42, and the surface of the second terminal 30 that is exposed to the inner side of the peripheral wall portion 42. Accordingly, by placing the molten sealing portion 245 within this recess, the electronic component 50, the connection portion between the first connection portion 24 and the first electrode 51, and the connection portion between the second connection portion 34 and the second electrode 52 can be easily covered by the sealing portion 245.

### Through Hole 246

The resin part 40 may also have a through hole 246. This through hole 246 passes through the placement surface 41 and the underside of the resin part 40. The through hole 246 exposes a part of the outer surface of the electronic component 50 that is different from the first electrode 51 and the second electrode 52 to the outside. In other words, the entire outer surface of the electronic component 50 is not covered by the sealing portion 245 and the resin part 40. The first electrode 51 and the second electrode 52 are not exposed to the outside through the through hole 246. The through hole 246 may be formed, for example, during the resin part forming step, or may be formed after the resin part forming step.

According to Embodiment 3, the sealing portion 245 can prevent water droplets from entering the opening 42A of the peripheral wall portion 42. Therefore, it is possible to prevent the first connection portion 24 and the second connection portion 34 from becoming conductive via water droplets after the electronic component 50 is melted.

### Embodiment 4

The following will describe Embodiment 4 of the present disclosure with reference to FIG. 12. An electronic component unit 310 according to Embodiment 4 is configured in substantially the same manner as in Embodiment 3, except for the configuration of a sealing portion 345 (an example of the cover member), and thus, descriptions of the same components, operations, and effects as in Embodiments 1 and 3 are omitted.

### Sealing Portion 345

The sealing portion 345 of Embodiment 4 is, for example, a moisture-proof coating agent. The sealing portion 345 adheres to the outer surface of the electronic component 50, the first connection portion 24, the second connection portion 34, and the placement surface 41, within the opening 42A of the peripheral wall portion 42. The sealing portion 345 does not need to fill up the entire space in the opening 42A.

### Embodiment 5

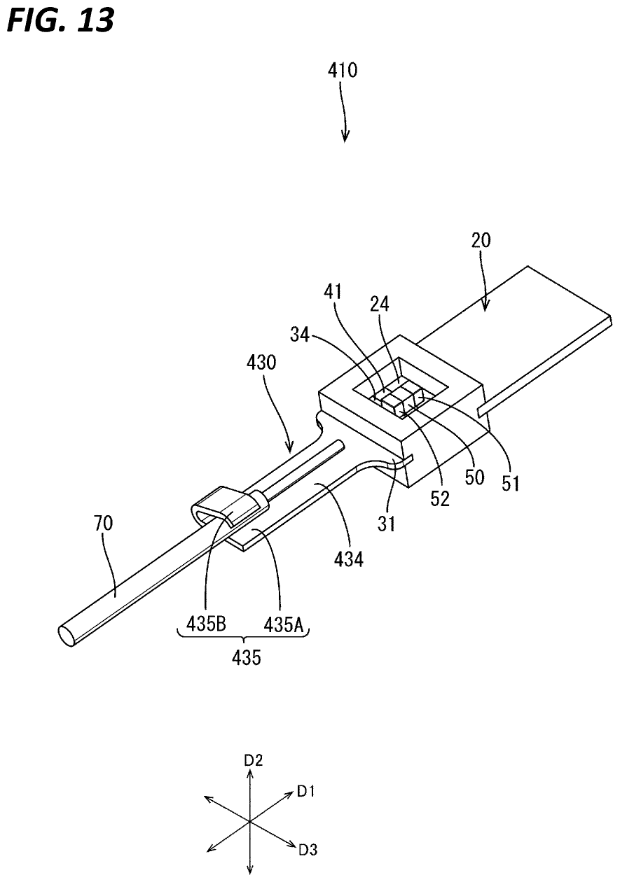

The following will describe Embodiment 5 of the present disclosure with reference to FIG. 13. An electronic component unit 410 according to Embodiment 5 is configured in substantially the same manner as in Embodiment 1, except for the configuration of a second terminal 430, and thus, descriptions of the same components, operations, and effects as in Embodiment 1 are omitted.

### Wire Pressing Portion 435

The second terminal 430 includes a plate-shaped portion 31, a wire connection portion 434, and a wire pressing portion 435 (an example of a fixing portion). The wire connection portion 434 is a plate-shaped member extending from the plate-shaped portion 31 in the first direction D1. The wire connection portion 434 is connected to the core wire of the wire 70 by soldering. The wire pressing portion 435 is arranged on the side of the wire connection portion 434 that is opposite to the plate-shaped portion 31. The wire pressing portion 435 has a base 435A formed continuously from the wire connection portion 434 in the first direction D1, and an extension 435B extending in a cantilever fashion from the base 435A in the third direction D3 (width direction of the second terminal 430). The insulation coating of the wire 70 is interposed between the base 435A and the extension 435B bent so as to approach the base 435A. This allows the wire 70 to be fixed to the second terminal 430. The second terminal 430 does not need to include the wire pressing portion 435.

### Embodiment 6

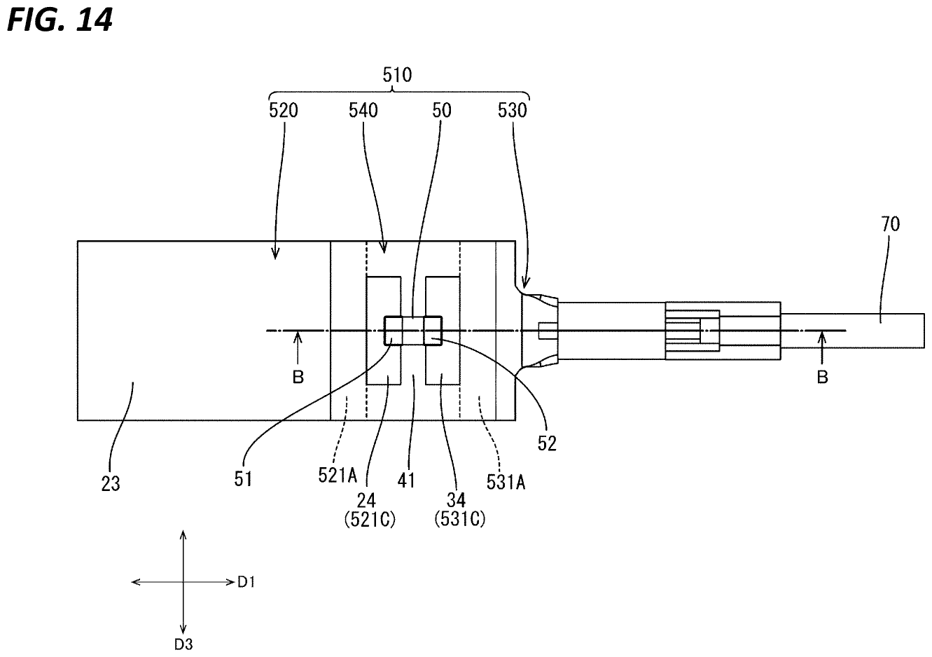

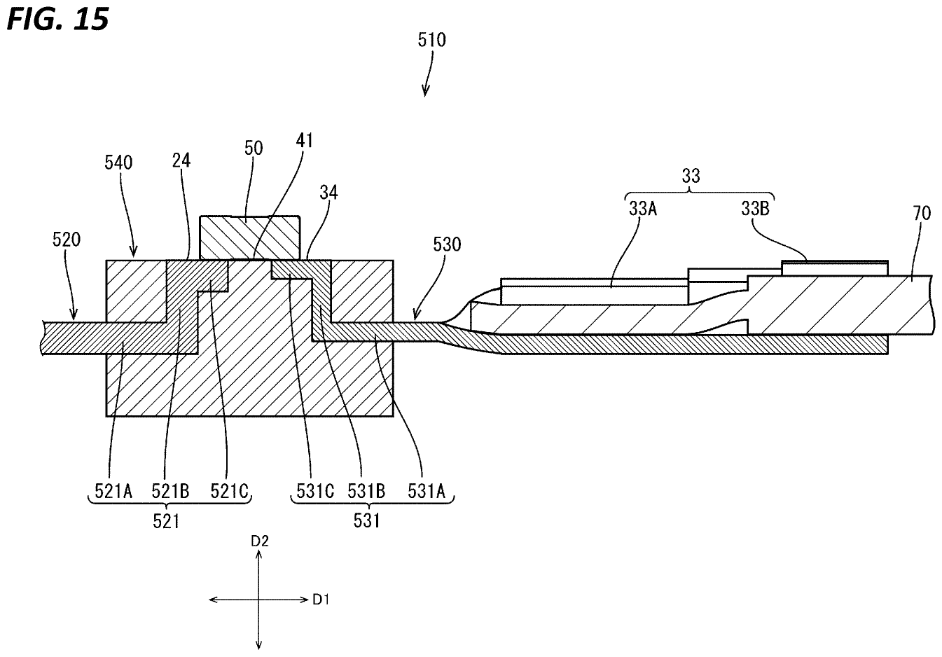

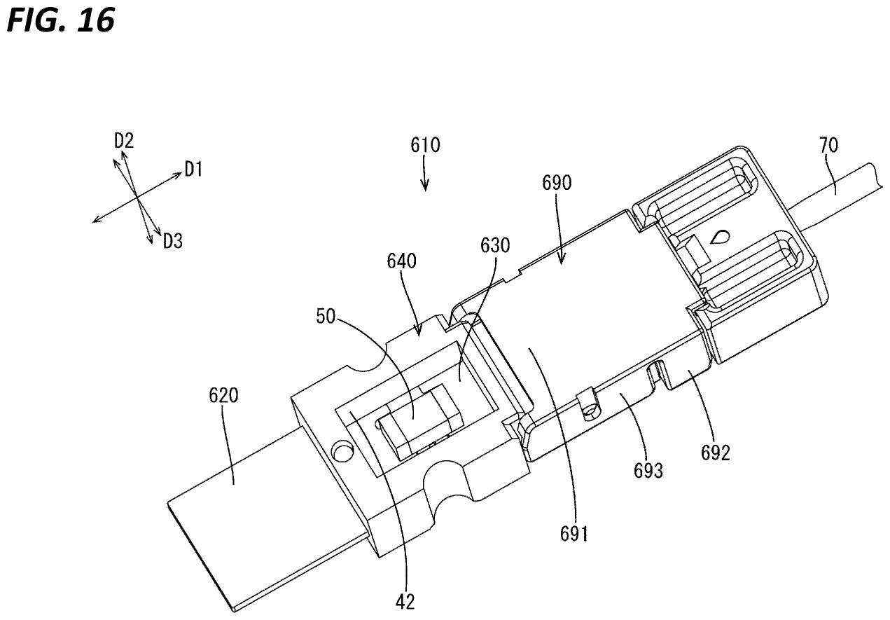

The following will describe Embodiment 6 of the present disclosure with reference to FIGS. 14 and 15. An electronic component unit 510 according to Embodiment 6 is configured in substantially the same manner as in Embodiment 1, except for the absence of the peripheral wall portion 42 and the configuration of plate-shaped portions 521 and 531, and thus, descriptions of the same components, operations, and effects as in Embodiment 1 are omitted.

The electronic component unit 510 includes a first terminal 520, a second terminal 530, a resin part 540, and the electronic component 50. As shown in FIG. 15, the resin part 540 does not have the peripheral wall portion 42. The upper surface of the resin part 540 functions as the placement surface 41.

The plate-shaped portion 521 of the first terminal 520 includes a first plate portion 521A, a second plate portion 521B, and a third plate portion 521C. The second plate portion 521B and the third plate portion 521C have a narrower width than that of the first plate portion 521A (see FIG. 14). The first plate portion 521A is a plate-shaped member continuous with the counterpart member connection portion 23 in the first direction D1. The second plate portion 521B extends upward from the end of the first plate portion 521A that is opposite to the counterpart member connection portion 23 in the first direction D1. The third plate portion 521C extends from the upper end of the second plate portion 521B in the first direction D1. The third plate portion 521C and the first plate portion 521A extend from the second plate portion 521B in opposite directions in the first direction D1. The upper surface of the third plate portion 521C is defined as the first connection portion 24.

The plate-shaped portion 531 of the second terminal 530 includes a first plate portion 531A, a second plate portion 531B, and a third plate portion 531C. The second plate portion 531B and the third plate portion 531C have a narrower width than that of the first plate portion 531A (see FIG. 14). The first plate portion 531A is a portion that is continuous with the barrel portion 33 in the first direction D1. The second plate portion 531B extends upward from the end of the first plate portion 531A that is opposite to the barrel portion 33 in the first direction D1. The third plate portion 531C extends from the upper end of the second plate portion 531B in the first direction D1. The third plate portion 531C and the first plate portion 531A extend from the second plate portion 531B in opposite directions in the first direction D1. The upper surface of the third plate portion 531C is defined as the second connection portion 34.

### Embodiment 7

The following will describe Embodiment 7 of the present disclosure with reference to FIGS. 16 to 28. In contrast to Embodiments 1 to 6 above, an electronic component unit 610 according to Embodiment 7 further includes a third terminal 680, so that a second terminal 630 and the wire 70 are connected to each other via the third terminal 680. In the following, description of the same members, operations, and effects as those in Embodiment 1 may be omitted.

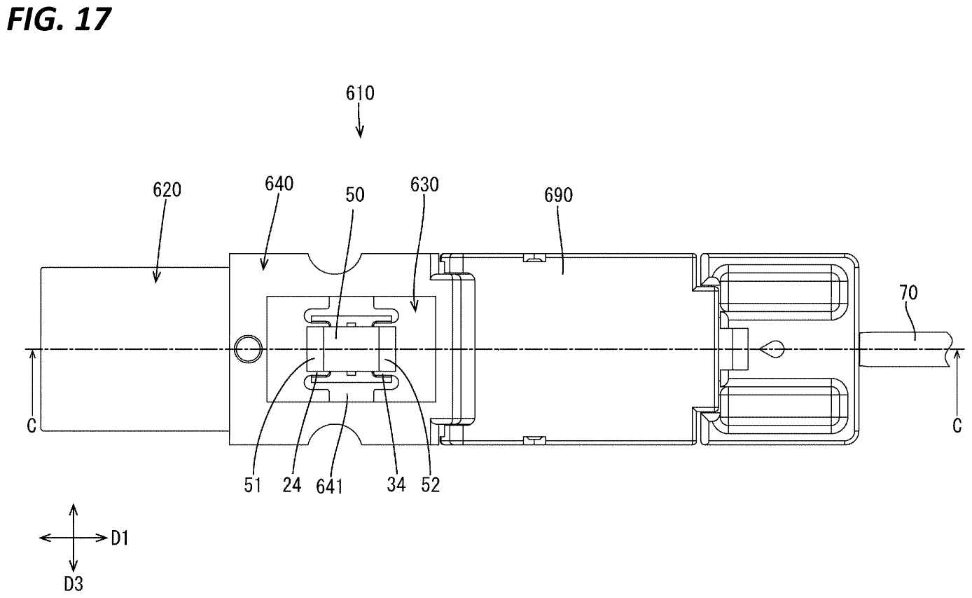

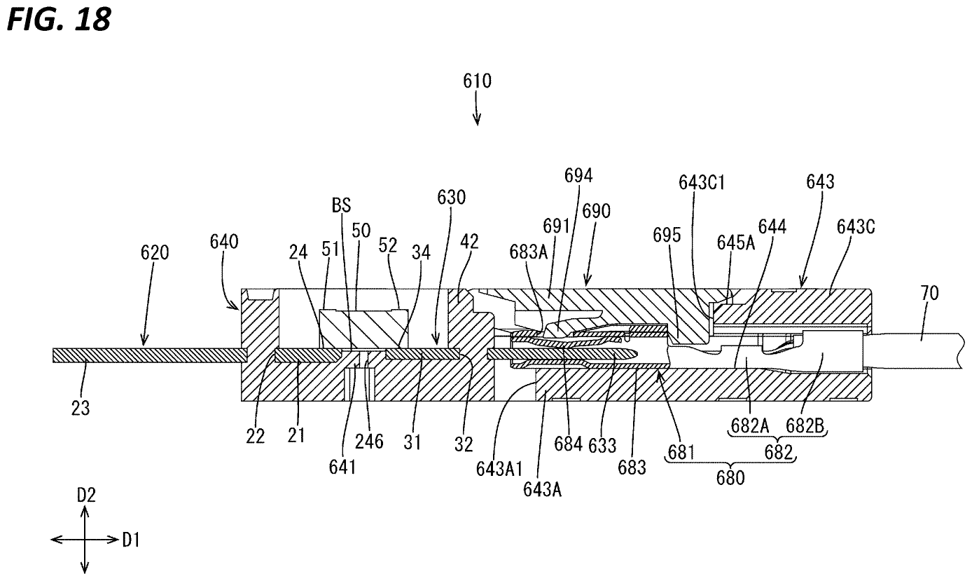

As shown in FIGS. 16 to 17, the electronic component unit 610 includes a first terminal 620, the second terminal 630, a resin part 640, and the electronic component 50. As shown in FIG. 18, the electronic component unit 610 includes the third terminal 680 disposed inside the resin part 640. The third terminal 680 is connected to the wire 70.

### First Terminal 620 and Cutout 625

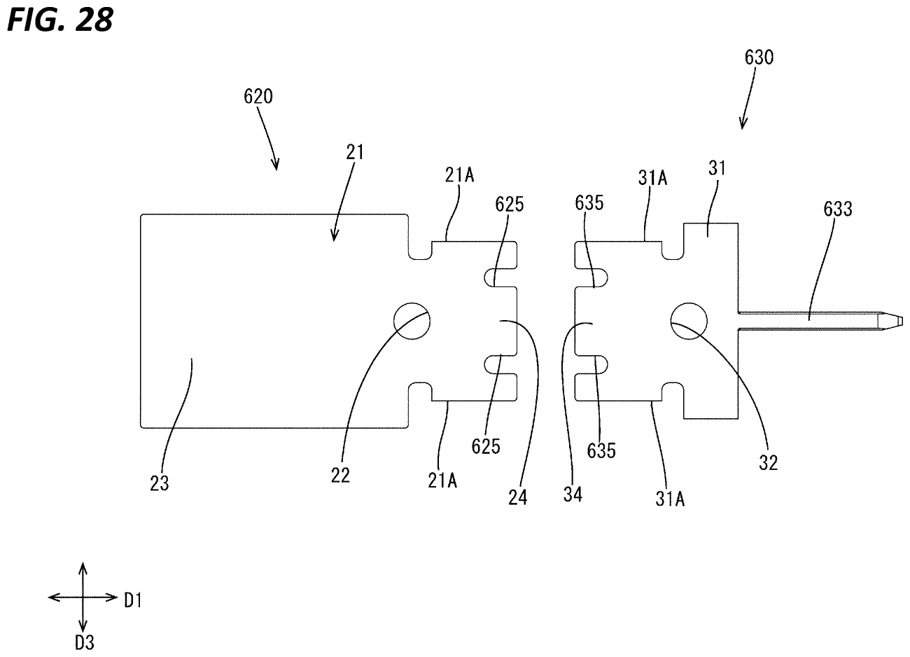

As shown in FIG. 28, similar to the first terminal 20 of Embodiment 1, the first terminal 620 has a plate-shaped portion 21, a through hole 22, two recesses 21A, a counterpart member connection portion 23, and a first connection portion 24. In addition, the first terminal 620 has cutouts 625, which are different configurations from the first terminal 20 of Embodiment 1. The cutouts 625 are formed as a pair by being recessed from one side of the outer edge of the first terminal 620 in the extending direction. The first connection portion 24 is defined by the cutouts 625. In other words, the first connection portion 24 and the cutouts 625 are adjacent to each other in the width direction of the first terminal 620. By the cutouts 625, the area of the first connection portion 24 when viewed in a plan view is set as appropriate.

If there is no cutout 625, when connecting the first electrode 51 of the electronic component 50 and the first connection portion 24 to each other by soldering, heat transfer to the first terminal 620 may become large. However, in the present embodiment, by appropriately adjusting the size of the first connection portion 24 using the cutouts 625, heat transfer to the first terminal 620 can be appropriately controlled.

### Second Terminal 630 and Tab Portion 633

Similar to the second terminal 30 of Embodiment 1, the second terminal 630 has a plate-shaped portion 31, a through hole 32, two recesses 31A, and a second connection portion 34. The plate-shaped portion 31 has the two recesses 31A at both ends of the second terminal 30 in the width direction (orthogonal to both the extending direction of the second terminal 30 and the thickness direction of the plate-shaped portion 31). The recesses 31A are formed by being recessed from the respective end edges of the second terminal 30 in the width direction. The second terminal 630 also includes a tab portion 633 (an example of the first terminal connection portion). The tab portion 633 is formed continuously from the plate-shaped portion 31 in the extending direction of the second terminal 630. The tab portion 633 is rod-shaped, and extends from an end edge of the plate-shaped portion 31 in the extending direction of the second terminal 630.

### Cutout 635

Similar to the first terminal 620, the second terminal 630 has cutouts 635. The cutouts 635 are formed as a pair by being recessed from the outer edge of the second terminal 630 that is opposite to the tab portion 633 in the extending direction. The second connection portion 34 is defined by the cutouts 635. In other words, the second connection portion 34 and the cutouts 635 are adjacent to each other in the width direction of the second terminal 630. By the cutouts 635, the area of the second connection portion 34 when viewed in a plan view is set as appropriate. By appropriately adjusting the size of second connection portion 34 using the cutouts 635, heat transfer to the second terminal 630 can be appropriately controlled.

### Third Terminal 680

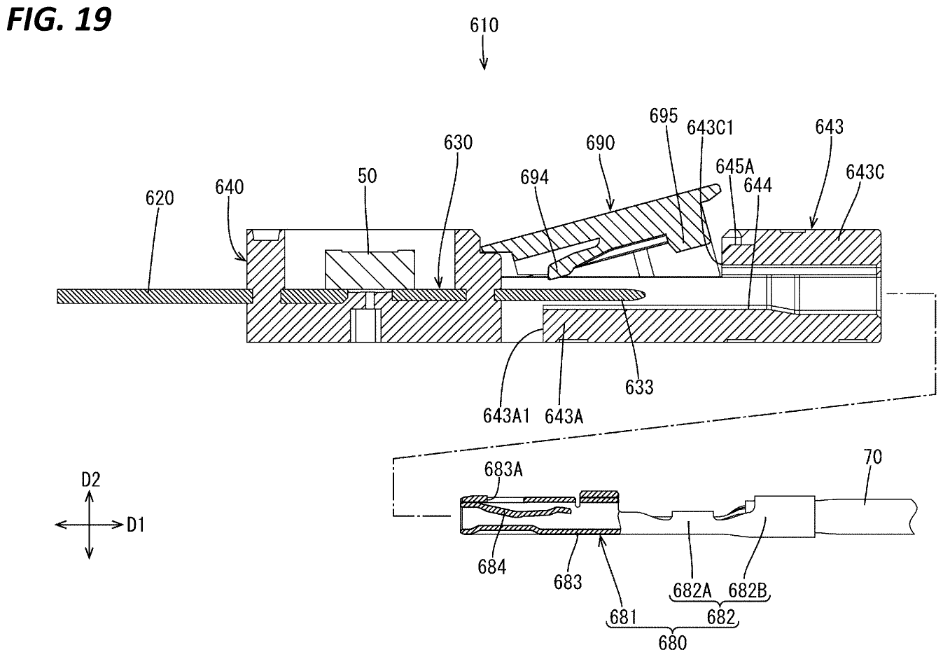

The third terminal 680 is made of a conductive metal. The metal constituting the third terminal 680 may be different from the metal constituting the first terminal 620 and metal constituting the second terminal 630. As shown in FIG. 19, the third terminal 680 includes a tubular connection portion 681 (an example of the second terminal connection portion) to be connected to the second terminal 630, and a barrel portion 682. The barrel portion 682 is formed continuously from the tubular connection portion 681 in the extending direction of the third terminal 680. The barrel portion 682 includes a core wire crimping section 682A crimped to the core wire of the wire 70, and an insulated coating crimping section 682B crimped to the insulation coating of the wire 70.

### Tubular Connection Portion 681

The tubular connection portion 681 includes, for example, a tubular wall portion 683 in a square tube shape, and an elastic contact piece 684 formed inside the tubular wall portion 683. The tubular wall portion 683 is open in the first direction D1. The elastic contact piece 684 extends from the inner surface of the tubular wall portion 683 and is capable of elastically deforming in a direction orthogonal to the first direction D1. The tubular connection portion 681 also includes an engagement hole 683A that passes through the tubular wall portion 683. As shown in FIGS. 18 to 20, when the tab portion 633 of the second terminal 630 is inserted into the tubular wall portion 683 and the elastic contact piece 684 comes into contact with the tab portion 633, the third terminal 680 and the second terminal 630 are electrically connected to each other. In other words, the tubular connection portion 681 and the tab portion 633 are electrically connected to each other by mating. Therefore, the second terminal 630 and the wire 70 are electrically connected to each other via the third terminal 680.

In the present embodiment, the second terminal 630 and the wire 70 are not directly connected to each other, but rather indirectly connected via the third terminal 680. Therefore, when electrically connecting, for example, the electronic component unit 610 and the wire 70, it is possible to suppress damage to the connection portion between the electronic component 50 and the second terminal 630 due to stress or the like. Accordingly, the reliability of the electrical connection between the electronic component unit 610 and the wire 70 is likely to be ensured.

### Resin Part 640

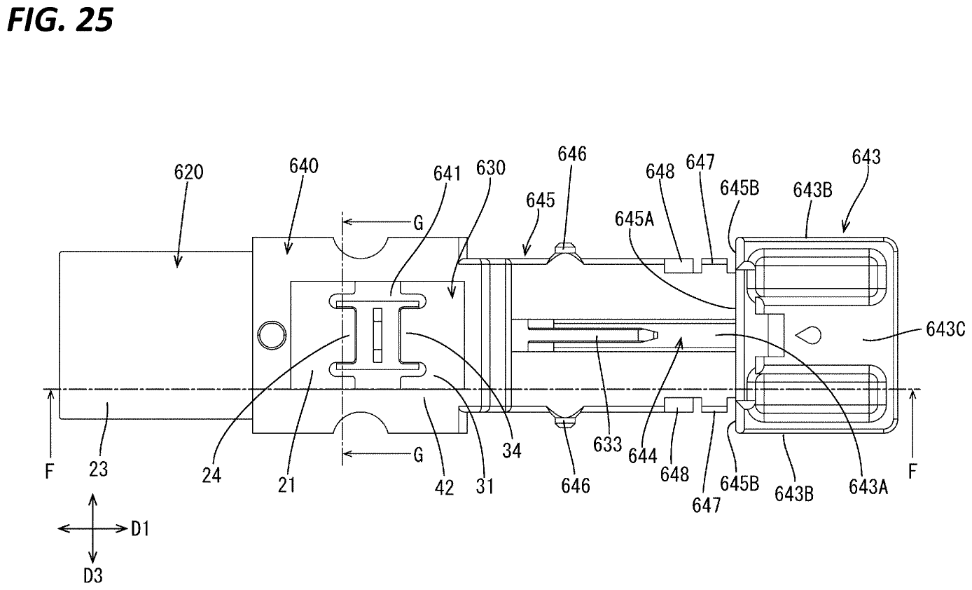

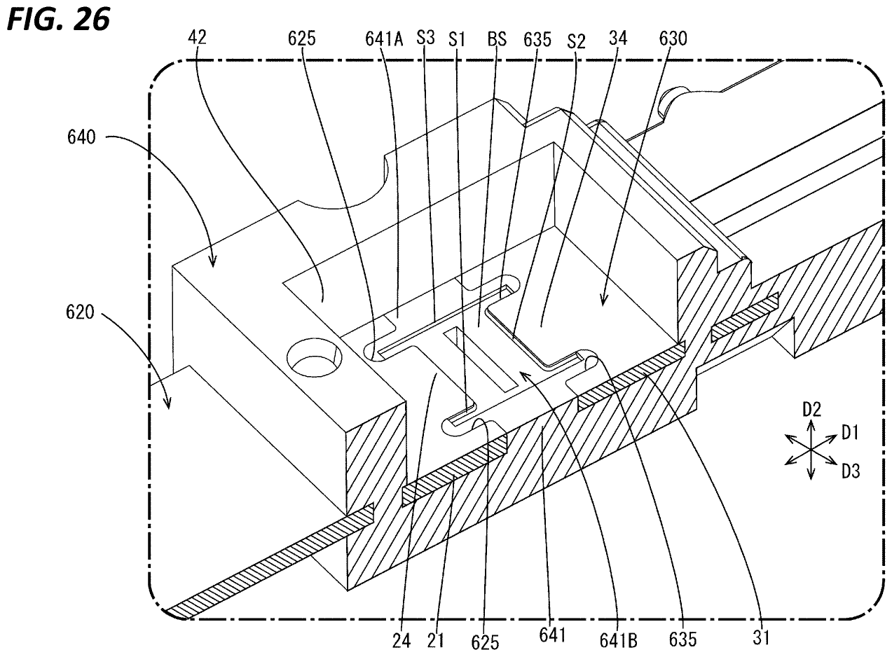

As shown in FIG. 25, the resin part 640 covers a part of the first terminal 620 and a part of the second terminal 630. Similar to Embodiment 1, the resin part 640 is formed in one piece with the first terminal 620 and the second terminal 630 by insert molding. The first terminal 620 and the second terminal 630 are fixed to the resin part 640. The resin part 640 includes an intermediate portion 641 that is disposed between the first terminal 620 and the second terminal 630 in the first direction D1. The resin part 640 maintains the distance between the first terminal 620 and the second terminal 630. The resin part 640 exposes the first connection portion 24, which is a part of the outer surface of the plate-shaped portion 21, and the second connection portion 34, which is a part of the outer surface of the plate-shaped portion 31. The first connection portion 24 and the second connection portion 34 are placed at a predetermined distance from each other in the first direction D1 by the resin part 640. Furthermore, the resin part 640 exposes the counterpart member connection portion 23 to the outside.

As shown in FIG. 26, the end face of the intermediate portion 641 on one side (the upper side) in the second direction D2 is defined as a reference surface 641A. The reference surface 641A is flush with the first connection portion 24 (outer surface of the plate-shaped portion 21) and the second connection portion 34 (outer surface of the plate-shaped portion 31). The reference surface 641A is orthogonal to the second direction D2 (vertical direction). The second direction D2 matches the thickness direction of the plate-shaped portions 21 and 31.

As shown in FIG. 18, the resin part 640 may have a through hole 246, similar to Embodiment 3. The through hole 246 passes through the intermediate portion 641 in the second direction D2.

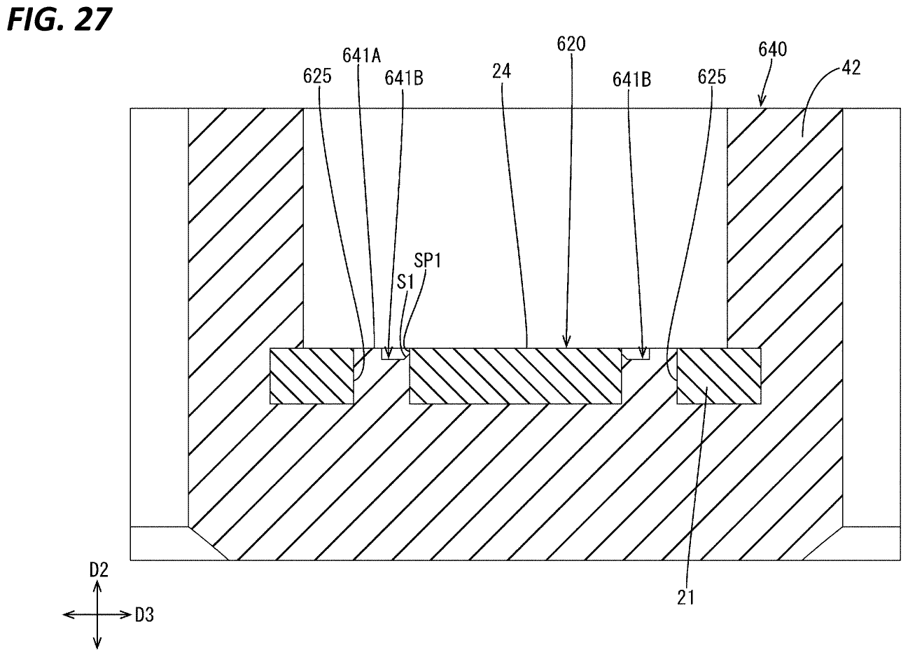

As shown in FIGS. 26 and 27, the resin part 640 includes a peripheral wall portion 42, similar to Embodiment 1. Also, the peripheral wall portion 42 extends from a reference surface 641A toward one side (the upper side) in the second direction D2. In other words, the peripheral wall portion 42 includes a portion that protrudes upward from the first connection portion 24 and the second connection portion 34. The peripheral wall portion 42 is disposed around the electronic component 50. Also, the peripheral wall portion 42 surrounds the first connection portion 24 and the second connection portion 34 in a direction orthogonal to the second direction D2.

### Groove 641B

The intermediate portion 641 has a groove 641B that is recessed from the reference surface 641A to the other side (the lower side) in the second direction D2. The groove 641B is recessed downward from the first connection portion 24 and the second connection portion 34. As shown in FIG. 26, the groove 641B consists of a bottom surface BS that is substantially parallel to the reference surface 641A, a first inner surface S1 that connects the bottom surface BS to the first connection portion 24, a second inner surface S2 that connects the bottom surface BS to the second connection portion 34, and a third inner surface S3 that connects the bottom surface BS to the reference surface 641A. Furthermore, the groove 641B is adjacent to the first connection portion 24 and the second connection portion 34 when viewed in the direction (second direction D2) orthogonal to the first connection portion 24 and the second connection portion 34. As shown in FIG. 18, the bottom surface BS faces the electronic component 50 in the second direction D2. A gap is provided between the bottom surface BS and the electronic component 50. As shown in FIGS. 26 and 27, the groove 641B are partially located inside the respective cutouts 625 and 635.

As shown in FIG. 27, as a result of the groove 641B being provided in the resin part 640, a part of the side surface (hereinafter referred to as a first side surface portion SP1) of the first terminal 620 that is continuous from the outer edge of the first connection portion 24 may be exposed from the resin part 640. Furthermore, the first connection portion 24 and the first inner surface S1 may be connected to each other via the first side surface portion SP1. Similarly, as a result of the groove 641B being provided in the resin part 640, a part of the side surface (hereinafter referred to as a second side surface portion) of the second terminal 630 that is continuous from the outer edge of the second connection portion 34 may be exposed from the resin part 640. Furthermore, the second connection portion 34 and the second inner surface S2 may be connected via the second side surface portion.

Note that the first connection portion 24 and the inner surface of the groove 641 may be directly connected to each other. The second connection portion 34 and the inner surface of the groove 641 may be directly connected to each other.

When the groove 641B is not provided, when forming the resin part 640 by insert molding, molten resin may move to the outer surfaces (upper surfaces) of the first connection portion 24 and second connection portion 34, and burrs may occur on the first connection portion 24 and the second connection portion 34. In such cases, burrs may cause poor electrical connection between the first connection portion 24 and the first electrode 51, or between the second connection portion 34 and the second electrode 52. However, in the present embodiment, since the groove 641B is provided in the intermediate portion 641, when forming the resin part 640, the molten resin is likely to move into the groove 641B rather than to the upper surfaces of the first connection portion 24 and second connection portion 34. This can prevent burrs from occurring in the first connection portion 24 and the second connection portion 34.

As shown in FIGS. 18 and 25, the resin part 640 includes a housing portion 643 formed continuously from the intermediate portion 641 and the peripheral wall portion 42. The housing portion 643 extends on the side of the intermediate portion 641 that is opposite to the first terminal 620. The housing portion 643 has a cavity 644 in which the third terminal 680 is housed. The cavity 644 extends in the first direction D1 and opens to one side (right side in the figures) in the first direction D1. At the end of the cavity 644 on the other side (left side in the figures) in the first direction D1, the tab portion 633 of the second terminal 630 and a part of the plate-shaped portion 31, which is the base end of the tab portion 633, are arranged.

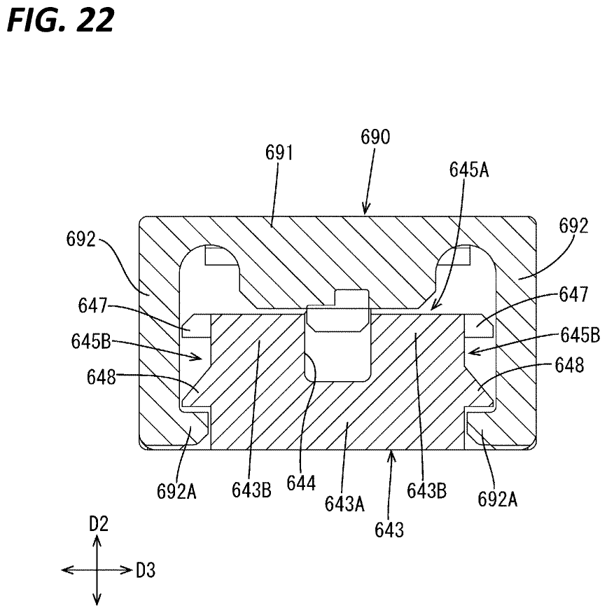

As shown in FIG. 25, the housing portion 643 includes a bottom wall 643A (see FIG. 18), a pair of side walls 643B, and a top wall 643C. As shown in FIG. 22, the pair of side walls 643B extend from both ends of the bottom wall 643A in the third direction D3 toward one side (the upper side) in the second direction D2. As shown in FIG. 18, the top wall 643C faces the bottom wall 643A in the second direction D2. As shown in FIG. 25, the top wall 643C connects the ends (upper ends) of the pair of side walls 643B on one side in the second direction D2 to each other. The cavity 644 is an internal space formed by the bottom wall 643A, the pair of side walls 643B, and the top wall 643C.

As shown in FIG. 18, a first communication hole 643C1 is provided at a position of the top wall 643C that is close to the intermediate portion 641. The first communication hole 643C1 passes through the top wall 643C in the second direction D2 and is in communication with the cavity 644. A second communication hole 643A1 is provided at an end of the bottom wall 643A that is close to the intermediate portion 641. The second communication hole 643A1 passes through the bottom wall 643A in the second direction D2 and is in communication with the cavity 644.

As shown in FIG. 25, a mounting recess 645 for mounting a later-described retainer 690 is formed in the region corresponding to approximately two-thirds of the opposite side (left side in the figure) of the housing portion 643 in the first direction D1. The mounting recess 645 has a first mounting recess 645A recessed from the outer surface of the top wall 643C and second mounting recesses 645B recessed from the outer surfaces of the pair of side walls 643B. Note that the end of the first mounting recess 645A that is close to the intermediate portion 641 reaches the peripheral wall portion 42. As shown in FIG. 18, the first mounting recess 645A is in communication with the first communication hole 643C1.

As shown in FIG. 25, the second mounting recesses 645B are in communication with the first mounting recess 645A. The housing portion 643 includes a shaft portion 646 protruding from the inner walls of the second mounting recesses 645B in the third direction D3, temporary engagement portions 647, and final engagement portions 648. The shaft portion 646 is substantially cylindrical in shape. The shaft portion 646 is disposed in portions of the inner walls of the second mounting recesses 645B that are close to the intermediate portion 641 with respect to the first direction D1. The temporary engagement portions 647 and the final engagement portions 648 are arranged at the ends of the inner walls of the second mounting recesses 645B that are opposite to the intermediate portion 641 with respect to the first direction D1. The temporary engagement portions 647 and the final engagement portions 648 are disposed in close proximity to each other. Each temporary engagement portion 647 is disposed on one side (the right side in the figure) of the corresponding final engagement portion 648 in the first direction D1. Furthermore, as shown in FIG. 22, the temporary engagement portion 647 is disposed on one side (the upper side) of the corresponding final engagement portion 648 in the second direction D2.

### Retainer 690

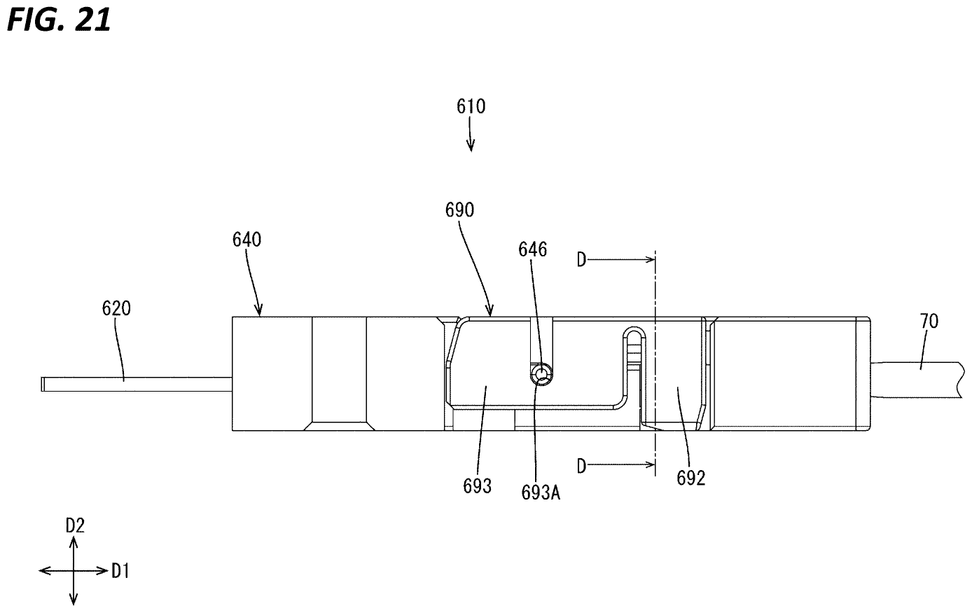

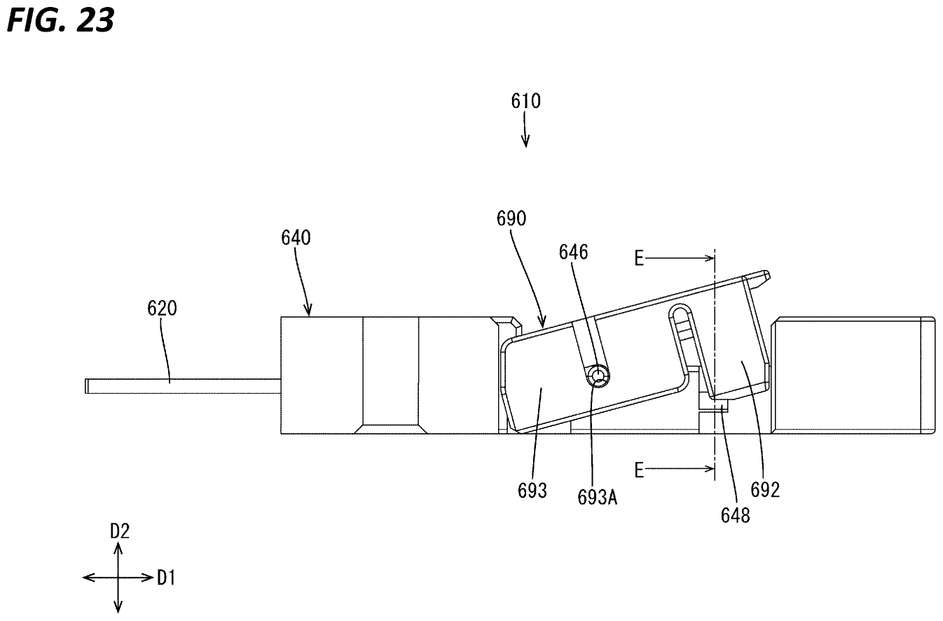

As shown in FIGS. 16 to 18, the electronic component unit 610 of the present embodiment includes the retainer 690 that is attached to the resin part 640. The retainer 690 is made of an insulating synthetic resin. The retainer 690 is designed to be attached to the resin part 640 in both a temporary engagement position (see FIG. 23) and a final engagement position (see FIG. 21). As shown in FIG. 22, the retainer 690 is in substantially a gate shape when viewed in the first direction D1. As shown in FIG. 16, the retainer 690 includes a body portion 691, a pair of lock pieces 692, and a pair of side walls 693. The pair of lock pieces 692 and the pair of side walls 693 extend from both ends of the body portion 691 in the third direction D3. The lock pieces 692 are located on one side (right side in the figure) of the side walls 693 in the first direction D1. As shown in FIG. 22, the body portion 691 is designed to be housed in the first mounting recess 645A. The pair of lock pieces 692 and the pair of side walls 693 are designed to be housed in the second mounting recess 645B.

As shown in FIG. 18, the retainer 690 includes a lance 694 and a stopper 695. The lance 694 extends from the body portion 691 toward the other side (left side in the figure) in the first direction D1 and toward the other side (the lower side) in the second direction D2. The lance 694 is configured to be elastically deformable with respect to the body portion 691. The stopper 695 protrudes from the body portion 691 toward the other side (the lower side) in the second direction D2. The stopper 695 has substantially a block shape.

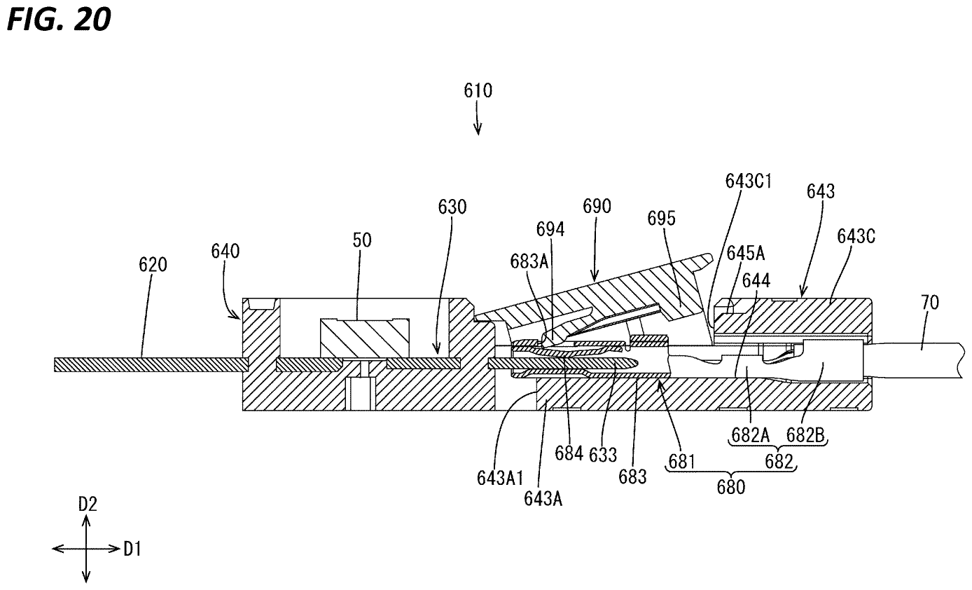

As shown in FIGS. 19 and 20, when the retainer 690 is in the temporary engagement position, the stopper 695 does not enter the cavity 644, and only the tip of the lance 694 enters the cavity 644 through the first communication hole 643C1. When the retainer 690 is in the temporary engagement position, insertion of the third terminal 680 is permitted through the opening of the cavity 644 on one side (right side in the figure) in the first direction D1. This is because the stopper 695 is not at a position where it interferes with the third terminal 680, and the lance 694 can elastically deform even if it interferes with the third terminal 680.

As shown in FIG. 18, in a state where the retainer 690 is in the final engagement position, the lance 694 and the stopper 695 are located within the cavity 644 through the first communication hole 643C1. When the third terminal 680 is in its normal position within the cavity 644, the lance 694 is engaged with the inner wall of the engagement hole 683A of the third terminal 680. The stopper 695 is engaged with the end of the tubular connection portion 681 on one side (right side in the figure) in the first direction D1. This allows the third terminal 680 to be retained within the cavity 644. In other words, the third terminal 680 can be retained with respect to the resin part 640. Note that the third terminal 680 is restricted from moving from its normal position within the cavity 644 toward the other side (left side in the figure) in the first direction D1 by coming into contact with the end edge of the plate-shaped portion 31 of the second terminal 630 placed within the cavity 644 (see FIG. 25). Whether the third terminal 680 is in its normal position within the cavity 644 or in a partially inserted state can be checked through the second communication hole 643A1.

As shown in FIGS. 21 and 23, the retainer 690 is provided with insertion holes 693A that pass through the respective side walls 693 in the third direction D3. The shaft portion 646 is inserted into the insertion holes 693A. The retainer 690 is rotatable about the shaft portion 646 and can move between the temporary engagement position and the final engagement position.

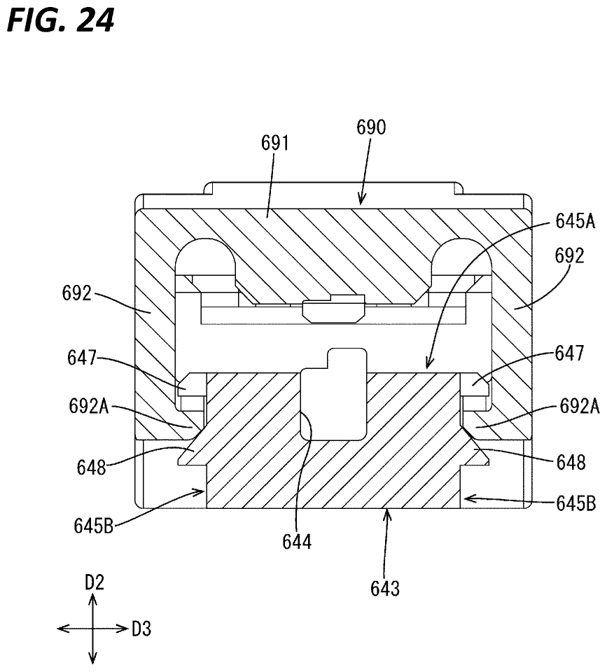

As shown in FIG. 24, the retainer 690 includes engaging protrusions 692A that protrude from the respective tips of the lock pieces 692 toward the inner walls of the second mounting recesses 645B. As a result of the engaging protrusion 692A being arranged between the temporary engagement portion 647 and the final engagement portion 648, the retainer 690 is held in the temporary engagement position. As shown in FIG. 22, as a result of the engaging protrusion 692A being arranged on the other side (the lower side) of the final engagement portion 648 in the second direction D2, the retainer 690 is held in the final engagement portion. Specifically, when the retainer 690 is in the final engagement position, and the engaging protrusions 692A are engaged with the final engagement portions 648, the retainer 690 is prevented from rotating from the final engagement position counterclockwise in FIG. 21. Also, as a result of the body portion 691 engaging with the inner wall of the first mounting recess 645A, the retainer 690 is prevented from rotating from the final engagement position clockwise in FIG. 21.

### Method for Manufacturing Electronic Component Unit 610

The configuration of the electronic component unit 610 has been described above, and the following describes an example of a method for manufacturing the electronic component unit 610. First, similar to an example of the method for manufacturing the electronic component unit 10 of Embodiment 1, the resin part 640 is formed in one piece with the first terminal 620 and the second terminal 630 by insert molding (see FIG. 25). Then, the first electrode 51 and the second electrode 52 of the electronic component 50 are mounted on the first connection portion 24 and the second connection portion 34, respectively.

Then, the retainer 690 is mounted on the resin part 640 and the retainer 690 is set in the temporary engagement position. In other words, the shaft portion 646 is inserted into the insertion holes 693A and the engaging protrusions 692A are placed in the gaps between the temporary engagement portion 647 and the final engagement portion 648.

When the retainer 690 is in the temporary engagement position, the third terminal 680, which is formed of a metal sheet material in advance and is connected to the wire 70, is inserted (see FIG. 19). During the insertion of the third terminal 680, the lance 694 interferes with the tubular connection portion 681 and undergoes elastic deformation. When the third terminal 680 is inserted into its normal position within the cavity 644, the lance 694 elastically recovers and enters the interior of the engagement hole 683A (see FIG. 20).

When the third terminal 680 is in its normal position within the cavity 644, then the retainer 690 is moved to the final engagement position. When rotating the retainer 690 from the temporary engagement position clockwise in FIG. 23, the lock pieces 692 elastically deform and the engaging protrusions 692A ride over the final engagement portions 648. When the engaging protrusions 692A are moved to the other side (the lower side) of the final engagement portions 648 in the second direction D2, the lock pieces 692 elastically recover and the retainer 690 reaches the final engagement position (see FIG. 22). During this process, the lance 694 enters the rear portion of the engagement hole 683A, so that the lance 694 and the inner wall of the engagement hole 683A are arranged so as to be engageable (see FIG. 18). Also, the stopper 695 is positioned on one side (right side in the figure) of the tubular connection portion 681 in the first direction D1, and is arranged so as to be engageable with the tubular connection portion 681. With this, the third terminal 680 is retained in the cavity 644. Accordingly, the manufacturing of the electronic component unit 610 is complete.

### Operations and Effects of Embodiment 7

(7-1) The electronic component unit 610 according to Embodiment 7 further includes: a third terminal 680 to which the wiring member (wire 70) is connected, wherein the second terminal 630 includes a first terminal connection portion (tab portion 633) connected to the third terminal 680, and the third terminal 680 includes a second terminal connection portion (tubular connection portion 681) connected to the first terminal connection portion by mating.

According to this configuration, connection between the wiring member and the second terminal 630 is facilitated.

(7-2) The electronic component unit 610 according to Embodiment 7 further includes: a retainer 690 attached to the resin part 640 and configured to retain the third terminal 680.

According to this configuration, the third terminal 680 can be held with respect to the resin part 640, so the third terminal 680 is likely to be positioned with respect to the resin part 640.

(7-3) In Embodiment 7, the first terminal 620 or the second terminal 630 has cutouts 625 and 635 that are recessed from an outer edge thereof, and the cutouts 625 and 635 define the first connection portion 24 or the second connection portion 34.

According to this configuration, by defining the first connection portion 24 or the second connection portion 34 using the cutouts 625 and 635, the size of the first connection portion 24 or the second connection portion 34 is appropriately adjusted, and it is thus possible to control heat transfer from the first connection portion 24 or the second connection portion 34 when mounting the electronic component 50.

(7-4) In Embodiment 7, the resin part 640 has a groove 641B that is recessed with respect to the first connection portion 24 and the second connection portion 34, inner surfaces (the first inner surface S1 and the second inner surface S2) constituting the groove 641B are respectively continuous with the first connection portion 24 and the second connection portion 34, and the groove 641B is partially located inside the cutouts 625 and 635.

According to this configuration, when forming the resin part 640, it is possible to prevent molten resin from moving to the outer surfaces of the first connection portion 24 and the second connection portion 34 via the cutouts 625 and 635. This can prevent burrs from occurring on the first connection portion 24 and the second connection portion 34.

### Other Embodiments

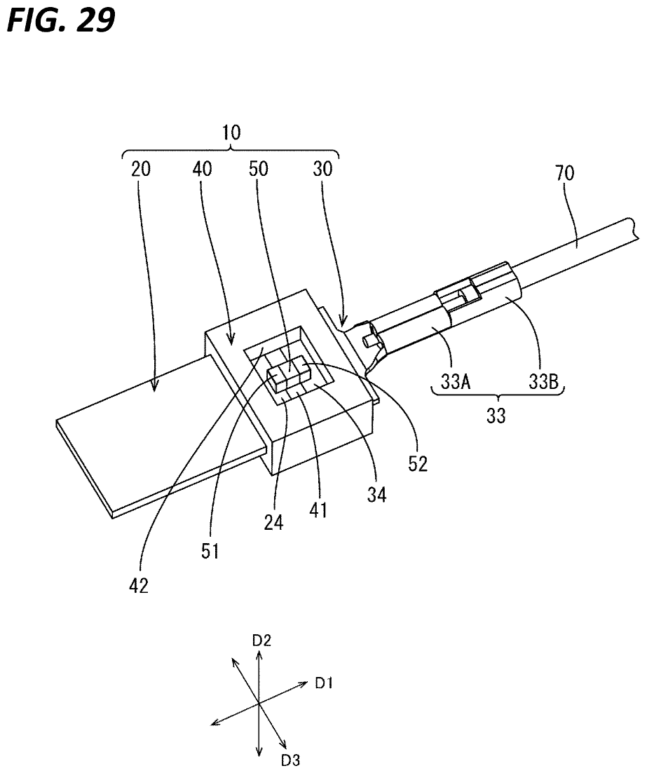

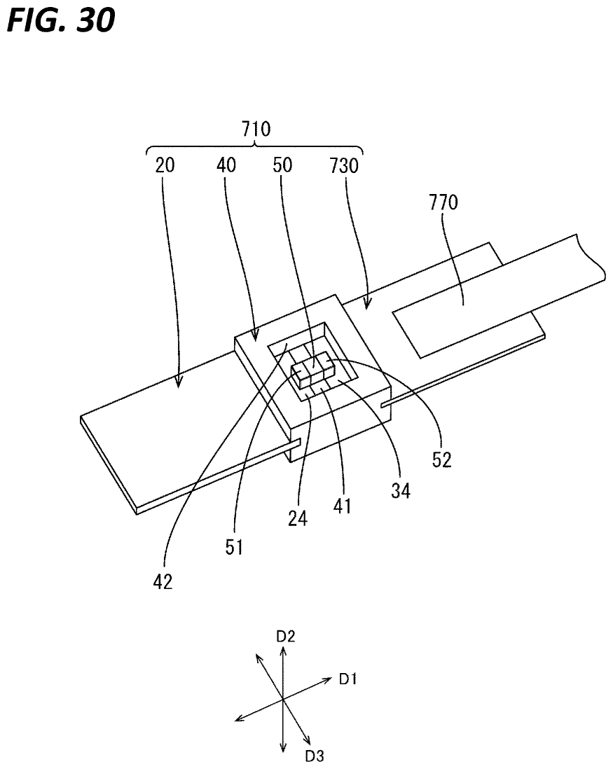

The above-described Embodiments 1 to 7 can be modified and implemented as follows. The above-described Embodiments 1 to 7 and the following modifications can be combined with each other and implemented as long as no technical contradiction arises.
The shapes of the first terminal, the second terminal, and the resin part, as well as their relative arrangement, are not limited to those described in Embodiments 1 to 7 above, and may be appropriately modified within the scope in which the objectives of the present disclosure can be achieved.
Although, in Embodiment 1, the end faces of the first terminal 20 and the second terminal 30 in the third direction D3 are substantially flush with the end face of the resin part 40 in the third direction D3 (see FIG. 1), the end faces of the first terminal and the second terminal in the third direction D3 do not need to be substantially flush with the end face of the resin part in the third direction D3. For example, as shown in FIG. 29, a mode in which the resin part 40 covers the end faces of the first terminal 20 and the second terminal 30 in the third direction D3 can be employed as a modification of Embodiment 1.
Although, in Embodiment 1, the counterpart member is the busbar 60, the counterpart member does not need to be a busbar and may be an electrode terminal, for example.
Although, in Embodiment 1, the wiring member is the wire 70, the wiring member does not need to be a wire. For example, as shown in FIG. 30, an electronic component unit 710 may also have a second terminal 730 connected to a flexible substrate 770, which is an example of the wiring member. Here, the flexible substrate 770 is, for example, a flexible printed circuit board or a flexible flat cable. The flexible substrate 770 and the second terminal 730 may be connected to each other by soldering.
Although, in Embodiment 1, the placement surface 41 of the resin part 40 is flush with the first connection portion 24 of the first terminal 20 and the second connection portion 34 of the second terminal 30, the placement surface may be formed with a step with respect to each of the first connection portion and the second connection portion.
Although, in Embodiment 1, the resin part 40 includes the placement surface 41 on which the electronic component 50 is mounted, the resin part does not need to include such a placement surface. In other words, the resin part does not need to have a surface that is in contact with the electronic component, and it suffices that the first electrode and second electrode of the electronic component are connected to the first connection portion of the first terminal and the second connection portion of the second terminal, respectively.
Although, in Embodiment 7, the electronic component unit 610 includes the retainer 690 that is attached to the resin part 640, the electronic component unit does not need to include such a retainer. If such a retainer is not provided, a stopper may be provided in the housing portion to retain the third terminal within the cavity.
Although, in Embodiment 7, the tab portion 633 is exemplified as the first terminal connection portion, and the tubular connection portion 681 is exemplified as the second terminal connection portion, the first terminal connection portion may serve as the tubular connection portion, and the second terminal connection portion may serve as the tab portion, for example.
The shape of the retainer 690 in Embodiment 7 above is one example, and the shape of the retainer may be changed as appropriate as long as it has the function of fixing the third terminal to the resin part. For example, in Embodiment 7 above, the retainer 690 is configured to be held on the resin part 640 in both the temporary engagement position and the final engagement position, but only the final engagement position may be provided, and the temporary engagement position may be omitted. Furthermore, a mode is also possible in which the retainer moves linearly with respect to the resin part, instead of rotating.

### LIST OF REFERENCE NUMERALS

1: Wiring module
10: Electronic component unit
20: First terminal
21: Plate-shaped portion
21A: Recess
22: Through hole
23: Counterpart member connection portion
24: First connection portion
30: Second terminal
31: Plate-shaped portion
31A: Recess
32: Through hole
33: Barrel portion
33A: Core wire crimping section
33B: Insulated coating crimping section (fixing portion)
34: Second connection portion
40: Resin part
41: Placement surface
42: Peripheral wall portion
43: Intermediate molded body
50: Electronic component
51: First electrode
52: Second electrode
60: Busbar (counterpart member)
70: Wire (wiring member)
110: Electronic component unit
144: Lid portion (cover member)
210: Electronic component unit
245: Sealing portion (cover member)
246: Through hole
310: Electronic component unit
345: Sealing portion (cover member)
410: Electronic component unit
430: Second terminal
434: Wire connection portion
435: Wire pressing portion (fixing portion)
435A: Base
435B: Extending portion
510: Electronic component unit
520: First terminal
521: Plate-shaped portion
521A: First plate portion
521B: Second plate portion
521C: Third plate portion
530: Second terminal
531: Plate-shaped portion
531A: First plate portion
531B: Second plate portion
531C: Third plate portion
540: Resin part
610: Electronic component unit
620: First terminal
625: Cutout
630: Second terminal
633: Tab portion (first terminal connection portion)
635: Cutout
640: Resin part
641: Intermediate portion
641A: Reference surface
641B: Groove
643: Housing portion
643A: Bottom wall
643A1: Second communication hole
643B: Side wall
643C: Top wall
643C1: First communication hole
644: Cavity
645: Mounting recess
645A: First mounting recess
645B: Second mounting recess
646: Shaft portion
647: Temporary engagement portion
648: Final engagement portion
680: Third terminal
681: Tubular connection portion (second terminal connection portion)
682: Barrel portion
682A: Core wire crimping section
682B: Insulated coating crimping section
683: Tubular wall portion
683A: Engagement hole
684: Elastic contact piece
690: Retainer
691: Body portion
692: Lock piece
692A: Engaging protrusion
693: Side wall
693A: Insertion hole
694: Lance
695: Stopper
710: Electronic component unit
730: Second terminal
770: Flexible substrate (wiring member)
BS: Bottom surface
S1: First inner surface
S2: Second inner surface
S3: Third inner surface
SP1: First side surface portion
D1: First direction
D2: Second direction
D3: Third direction

1. An electronic component unit comprising:
a first terminal configured to be electrically connected to a counterpart member;
a second terminal configured to be electrically connected directly or indirectly to a wiring member;
a resin part configured to cover a part of the first terminal and a part of the second terminal; and
an electronic component,
wherein the resin part maintains a distance between the first terminal and the second terminal,
the first terminal includes a first connection portion exposed from the resin part,
the second terminal includes a second connection portion exposed from the resin part, and
the electronic component includes a first electrode mounted on the first connection portion, and a second electrode mounted on the second connection portion.

2. The electronic component unit according to claim 1,
wherein the resin part includes a peripheral wall portion that has a portion protruding from the first connection portion and the second connection portion and is arranged in the periphery of the electronic component.

3. The electronic component unit according to claim 2,
wherein the peripheral wall portion surrounds the first connection portion and the second connection portion.

4. The electronic component unit according to claim 1, further comprising:
a cover member configured to cover the electronic component.

5. The electronic component unit according to claim 1, further comprising:
a third terminal to which the wiring member is connected,
wherein the second terminal includes a first terminal connection portion connected to the third terminal, and
the third terminal includes a second terminal connection portion connected to the first terminal connection portion by mating.

6. The electronic component unit according to claim 5, further comprising:
a retainer attached to the resin part and configured to retain the third terminal.

7. The electronic component unit according to claim 1,
wherein the first terminal or the second terminal has cutouts that are recessed from an outer edge thereof, and
the cutouts define the first connection portion or the second connection portion.

8. The electronic component unit according to claim 7,
wherein the resin part has a groove that is recessed with respect to the first connection portion and the second connection portion,
inner surfaces of the groove are respectively continuous with the first connection portion and the second connection portion, and
the groove is partially located inside the cutouts.

9. The electronic component unit according to claim 1,
wherein a thickness of the first terminal in the first connection portion is different from a thickness of the second terminal in the second connection portion, and
the first connection portion and the second connection portion are arranged at the same height.

10. A method for manufacturing an electronic component unit, the method comprising:
a terminal forming step of forming a first terminal and a second terminal;
a resin part forming step of forming, through insert molding, a resin part that covers a part of the first terminal and a part of the second terminal, the resin part exposing an outer surface of the first terminal so that the exposed portion serves as a first connection portion and exposing an outer surface of the second terminal so that the exposed portion serves as a second connection portion; and
a mounting step of mounting, among a first electrode and a second electrode of an electronic component, the first electrode on the first connection portion and the second electrode on the second connection portion.
